(19) United States
(12) Patent Application Publication
(10) Pub. No.: US 2011/0215930 A1
(43) Pub. Date: Sep. 8, 2011

(54) METHOD AND SYSTEM FOR INTERPRETING MEDICAL IMAGE DATA

(76) Inventors: Cooper G. Lee, Laguna Niguel, CA (US); Brian Brooks, Lexington, KY (US)

(21) Appl. No.: 12/766,018

(22) Filed: Apr. 23, 2010

Related U.S. Application Data
(60) Provisional application No. 61/310,850, filed on Mar. 5, 2010.
(60) Provisional application No. 61/314,623, filed on Mar. 17, 2010.

(51) Int. Cl. G08B 23/00; G06K 9/00

(52) U.S. Cl. 340/573.1; 382/128

(57) ABSTRACT

According to one aspect, methods and systems for identifying a pattern of injury from thermal data are disclosed. Some embodiments provide for medical image collection and analysis for a region of interest on a patient and determine whether a pattern of injury, such as a pattern of injury indicative of a pressure ulcer, is present or is likely. Example systems and methods obtain thermal and visual light images of regions of interest and analyze the image data to detect whether a pattern of injury is present. Statistically significant deviations in the image data can be identified and a determination of whether the pattern of injury is exists can be performed automatically, and can be forwarded to an appropriate person for confirmation where desirable or necessary. Other aspects include remote and/or automated routing and billing that preserves the anonymity of the patient, and automated correlation of thermal and visual image data.

### RELATED APPLICATIONS

This application claims priority under 35 U.S.C. §119(e) to U.S. Provisional Application Ser. No. 61/310,850 entitled “METHOD AND SYSTEM FOR INTERPRETING MEDICAL IMAGE DATA,” filed on Mar. 5, 2010, which is incorporated herein by reference in its entirety. This application also claims priority under 35 U.S.C. §119(e) to U.S. Provisional Application Ser. No. 61/314,623 entitled “METHOD AND SYSTEM FOR INTERPRETING MEDICAL IMAGE DATA,” filed on Mar. 17, 2010, which is incorporated herein by reference in its entirety.

### BACKGROUND

Significant time, energy, and investment have taken place in the medical industry relating to maintaining healthy patients without requiring intervention of the doctor. One underlying thought in this shift in medical thinking relates to the old maxim that an ounce of prevention is worth a pound of cure.

Along similar lines, much effort has been and continues to be expended in treating patients after significant medical issues have arisen. In the context of wound care, prevention is worth significantly more than treatment. Given a population of reduced mobility patients, it is almost a certainty that pressure ulcers will occur in the population over time. Various methods have attempted to combat the outbreak of pressure ulcers in reduced mobility patients by increasing mobility of the patients, including having nursing and medical staff manually move the patient if the patient is unable or unwilling to do so. These prophylactic measures have been largely unsuccessful because although it is realized that a large portion of the population will develop a pressure ulcer, no effective early detection mechanisms exist, and specific criteria applicable to individual patients is unavailable. There is known in the art some generic indicators for patients at risk of developing pressure ulcers. For example, the Braden Scale Scoring system identifies patients that are at higher risk for developing pressure ulcers. But, the scoring system identifies generic indicators rather than providing insight into a particular patient, and while the scoring system identifies at risk populations, it cannot assist in identifying where a particular pressure ulcer may develop or permit medical staff to take action before the wound becomes apparent.

### SUMMARY

In broad overview, embodiments of the present invention are directed to a medical image collection and analysis system that is capable of analyzing a region of interest on a patient and determining whether a pattern of injury, such as a pattern of injury indicative of a pressure ulcer, is present or is likely. The system obtains thermal and visual light images of the region of interest, and analyzes the image data to detect whether a pattern of injury is present or likely. Statistically significant deviations in the temperature values associated with captured image data can be identified based upon criteria established through clinical trials. A determination of whether the pattern of injury is present or likely may be performed automatically, and may be forwarded to an appropriate person for confirmation where desirable or necessary. In one embodiment, an infrared imaging system detects and records skin temperature and potential injury patterns, providing visual and quantitative documentation of body temperature data. The system can map changes in skin blood flow by translating temperature data into pictures. Interpretation of the temperature data permits diagnosis of injury patterns. Detection of injury patterns permits injury detection and treatment before they are visible to the naked eye. Other aspects include remote and/or automated routing and billing that preserves the anonymity of the patient, and automated correlation of thermal and visual image data.

In one setting, the detection of a pattern of injury or the potential for injury can be used in conjunction with a patient admission process. Patients can be screened for existing conditions at the time they are admitted. Any injury or potential for injury becomes part of the patient's history at admission, and in some settings, this can insure that treatment options for these injuries are covered by health insurance plans. Screening for potential and any non visualized injuries, and in particular, present or likely pressure ulcers can significantly improve care for an individual patient. Lacking in conventional systems is the capability to provide localized information on the presence of potential and/or non visualized pressure ulcers. Information on the potential development of a pressure ulcer that is localized to a particular area of a patient's body can provide a clinician with treatment options that may effectively reverse the development of any pressure ulcer.

According to one aspect of the present invention, a method for identifying risk characteristics is provided. The method comprises gathering historical data for at least one patient, imaging the at least one patient with a thermal imaging camera; storing the historical and image data, and interpreting the historical and image data against at least one risk characteristic. According to one embodiment of the present invention, the method further comprises an act of adjusting the risk characteristic based upon statistical analysis of historical and image data of a plurality of patients. According to another embodiment of the invention, the gathering of patient data for the at least one patient occurs anonymously. According to another embodiment of the invention, the method further comprises an act of associating with the at least one patient a unique identifier. According to another embodiment of the invention, the method further comprises generating an interpretation request.

According to one embodiment of the present invention, the interpretation request is generated in response to an input request. According to another embodiment of the invention, the interpretation request is generated in response to an automated identification of the at least one risk characteristic. According to another embodiment of the invention, the at least one risk characteristic comprises temperature variation over distance. According to another embodiment of the invention, the at least one risk characteristic includes the Braden Scale scoring factors.

According to another aspect of the present invention, a method for anonymous analysis of data is provided. The method comprises acts of generating a unique identifier, capturing data associated with at least one patient, associating the unique identifier to the data associated with the at least one patient, storing the data associated with the at least one patient, analyzing the data associated with the at least one patient for statistical indicators of medical conditions. According to one embodiment of the present invention, the method further comprises an act of requesting interpretation of the data associated with the at least one patient. According to another embodiment of the invention, the request for interpretation is automatically generated. According to another embodiment of the invention, the request for interpretation is input manually. According to another embodiment of the invention, the act of generating the unique identifier occurs in response to request at a remote location to enter patient information. According to another embodiment of the invention, the unique identifier is generated at a remote system.

According to one embodiment of the present invention, the act of capturing data associated with the at least one patient further comprises capturing thermal image data of the at least one patient. According to another embodiment of the invention, the act of storing the data associated with the at least one patient further comprises storing the data associated with the at least one patient on a remote server. According to another embodiment of the invention, analyzing the data associated with the at least one patient for statistical indicators of medical conditions occurs on the remote server. According to another embodiment of the invention, analyzing the data associated with the at least one patient for statistical indicators of a medical condition further comprises identifying at least one risk characteristic associated with the medical condition. According to another embodiment of the invention, the medical condition comprises a pressure ulcer.

According to yet another aspect of the present invention, a system for identifying risk characteristics is provided. The system comprises an interface for inputting at least one patient's information, a communication network for transmitting data associated with the at least one patient, wherein the data comprises, at least in part thermal image data, and an interpretation engine adapted to request interpretation of the data associated with the at least one patient, an analysis engine to identify at least one risk characteristic associated with the data. According to another embodiment of the invention, the system further comprises a thermal imaging camera.

According to a further aspect of the present invention, a system for anonymous analysis of data is provided. The system comprises a server adapted to generate a unique identifier for at least one patient, an interface for inputting data associated with the at least one patient, a database adapted to stored at least one thermal image and data associated with the at least one patient, and an analysis engine adapted to identify statistical indicators of medical conditions. According to one embodiment of the present invention, the system further comprises a thermal imaging camera.

According to another aspect of the present invention, a method for identifying risk characteristics is provided. The method comprises acquiring historical data for at least one patient, acquiring image data for the at least one patient captured with a thermal imaging camera, and interpreting the historical and image data against at least one risk characteristic.

According to still another aspect of the present invention, a method for identifying risk characteristics is provided. The method comprises acquiring historical data for at least one patient, acquiring image data for the at least one patient, at least a portion captured with a thermal imaging camera, and determining at least one risk characteristic from analysis of patient data. According to one embodiment of the present invention, the act of determining at least one risk characteristic from analysis of the patient data comprises detecting at least one statistical variation in thermal image data.

According to yet another aspect, a method for identifying a pattern of injury from thermal data is provided. The method comprises acts of imaging at least one patient with a thermal imaging camera, processing the thermal image data to identify temperature variation meeting a first threshold, calculating a baseline for the thermal image data, processing each of thermal image data value meeting the first threshold against the baseline to determine if a second threshold is satisfied, and generating an alert for an indication of a pattern of injury based on the values that meet the second threshold. According to one embodiment, the act of imaging the at least one patient occurs at a point of interest on the at least one patient. According to another embodiment, the act of imaging the at least one patient includes an act of generating a visual light image.

According to one aspect of the present invention, a computer implemented method for identifying a pattern of injury from thermal data is provided. The method comprises acts of imaging an area of interest on a subject with a thermal imaging camera to generate thermal image data, identifying, by a computer processor, at least one temperature value having a temperature variation meeting a first threshold from the thermal image data, calculating, by the computer processor, a baseline temperature from the thermal image data obtained from the area of interest, comparing, by the computer processor, each of the at least one temperature values meeting the first threshold against the baseline to determine if a second threshold is satisfied for the at least one temperature value, identifying the area of interest as being a potential pattern of injury based on the at least one temperature value that meets the second threshold. According to one embodiment of the present invention, the temperature variation meeting a first threshold includes a minimum temperature difference between the at least one temperature value and at least one other temperature value within the thermal image data obtained from the area of interest. According to another embodiment of the invention, the method further comprises an act of identifying the area of interest on the subject to image prior to conducting a thermal examination of the subject. According to another embodiment of the invention, the act of calculating the baseline temperature includes an act of excluding a temperature value from the calculation of the baseline.

According to one embodiment of the present invention, the temperature value to exclude includes the temperature value meeting the first threshold to be compared against the baseline. According to another embodiment of the invention, the act of comparing each of the temperature values meeting the first threshold against the baseline to determine if the second threshold is satisfied includes an act of determining a minimum temperature difference between at least one temperature value meeting the first threshold and the baseline exists. According to another embodiment of the invention, the act of calculating the baseline temperature from the thermal image data of the area of interest includes acts of establishing a mean temperature for the thermal image data, excluding from the mean temperature a data value meeting the first threshold, wherein the data value excluded comprises the data value to be evaluated against the second threshold. According to another embodiment of the invention, the method further comprises an act of extracting an inner region of temperature values from the thermal image data obtained from the area of interest, and wherein the acts of identifying, calculating and comparing occur against the inner region. According to another embodiment of the invention, the method further comprises an act of generating a data map of the thermal image data obtained from the area of interest, wherein a position of each temperature value reflects a distance from a center of the data map. According to another embodiment of the invention, the act of imaging the area of interest includes an act of generating a visual light image of the area of interest.

According to one embodiment of the present invention, the method further comprises an act of generating an interpretation request. According to another embodiment of the invention, the interpretation request is generated in response to an automated identification of the pattern of injury. According to another embodiment of the invention, the method further comprises an act of storing the thermal image data and any subject information anonymously. According to another embodiment of the invention, the method further comprises an act of generating a probability of pressure ulcer development for the subject based on the pattern of injury.

According to another aspect of the present invention, a computer-readable medium is provided, which includes instructions that when executed cause a computer system to perform a method for identifying a pattern of injury from thermal data. According to one embodiment, the computer-readable medium contains instructions that perform the preceding acts of the method for identifying a pattern of injury from thermal data, individually, separately, or in any combination.

According to yet another aspect of the present invention, a system for identifying a pattern of injury from thermal image data is provided. The system comprises an imaging component configured to capture thermal image data from an area of interest on a subject, an evaluation component configured to identify at least one temperature value having a temperature variation meeting a first threshold from the thermal image data obtained from the area of interest, calculate a baseline temperature from the thermal image data obtained from the area of interest, and compare each of the at least one temperature values meeting the first threshold against the baseline to determine if a second threshold is satisfied, and a communication component configured to generate an alert for an indication of a pattern of injury based on the values that meet the second threshold. According to one embodiment of the present invention, the evaluation component is further configured to identify at least one temperature value having a temperature variation meeting a first threshold, by establishing the at least one temperature value meets a minimum temperature difference between the at least one temperature value and at least one other temperature value within the thermal image data obtained from the area of interest. According to another embodiment of the invention, the evaluation component is further configured to calculate the baseline from a mean of temperature values excluding the at least one temperature value to compare against the baseline.

According to yet another embodiment of the present invention, the evaluation component is further configured to calculate the baseline for each of the temperature values meeting the first threshold compared against the baseline. According to another embodiment of the invention, the evaluation component is further configured to extract an inner region of temperature values from the thermal image data obtained from the area of interest. According to another embodiment of the invention, the communication component is further configured to generate a request for interpretation. According to another embodiment of the invention, the system further comprises storage component configured to store subject information and thermal image data anonymously. According to another embodiment of the invention, the evaluation component is further configured to generate a probability of pressure ulcer development for the subject based on the pattern of injury.

One should appreciate that the various aspects of the invention disclosed herein are not mutually exclusive. The teachings associated with the various aspects of the invention disclosed herein can be used together and/or in conjunction.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is an illustration of one example system architecture for acquiring and analyzing thermal image data, according to aspects of the invention;

FIG. 2 is a flow diagram of one example process for establishing an indication of a pattern of injury from thermal image data, according to aspects of the invention;

FIG. 3 is a flow diagram of one example process for interpreting thermal image data, according to aspects of the invention;

FIGS. 4A-C illustrate example formats for thermal data mappings of thermal image data, according to aspects of the invention;

FIG. 5 is an illustration of one example file for storing thermal image data, according to aspects of the invention;

FIG. 6 is a flow diagram of one example process for acquiring information and thermal data while supporting anonymous acquisition, according to aspects of the invention;

FIG. 7 is an illustration of an example communication flow between host computer systems and a thermal medical image server, according to aspects of the invention;

FIG. 8 is a flow diagram of one example process for developing and refining statistical models for detecting patterns of injury, according to aspects of the invention;

FIGS. 9A-O are screen captures of example user interfaces displayed by a system for detecting a pattern of injury from thermal image data, according to aspects of the invention;

FIG. 10 is a block diagram of an example system for detecting a pattern of injury from thermal image data, according to aspects of the invention;

FIG. 11 is a block diagram of an example system for detecting a pattern of injury from thermal image data, according to aspects of the invention; and

FIG. 12 is a block diagram of a system for detecting a pattern of injury from thermal image data, according to aspects of the invention.

### DETAILED DESCRIPTION

According to one aspect, a method and system are provided for the automated detection of risk indicators. In one example, a risk potential is calculated automatically which provides for early and/or predictive diagnosis of wound outbreaks. In another example, the eruption of pressure ulcers can be predicted in patients, thereby allowing for specific protocols to preventatively treat these wounds. In one implementation, a system for automatically determining risk characteristics includes a thermal imaging device such as a thermal imaging camera, and a unique ID associated with the imaging device, treating facility, and/or the patient. In one embodiment, the system also includes a database for recording related history and symptom information (present and historical indicators) that are used in calculating risk characteristics. The system captures thermal image data associated with predetermined areas of a subject, and the thermal image data is archived by the system in a variety of formats. The captured data can be processed into individual or aggregate temperature readings that correspond to a physical location on a subject's body. In some examples, the thermal image device captures temperature data as an infrared image, which can be processed to obtain the component temperature values. In another example, two images are created at the time of temperature acquisition, a grayscale thermal image, and a visual light digital image of the target area. The pairing can permit more thorough review of the imaged areas.

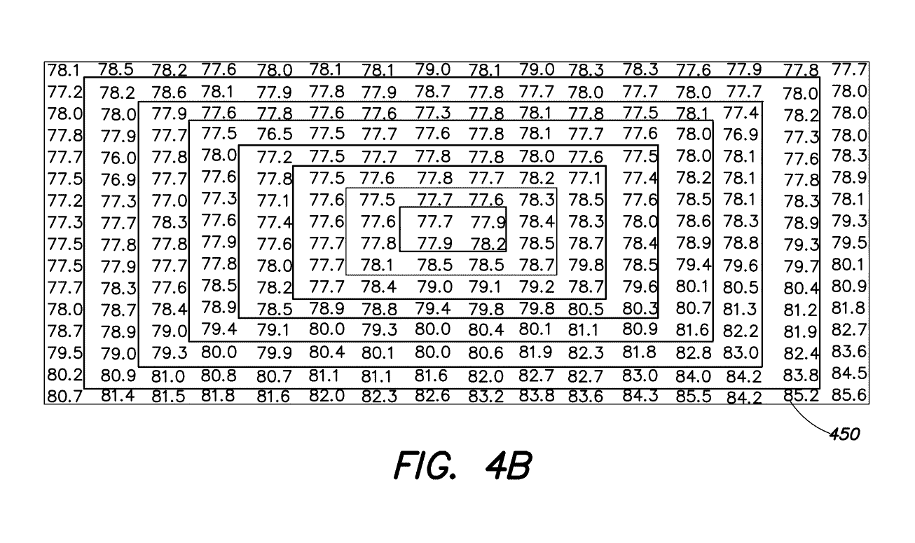

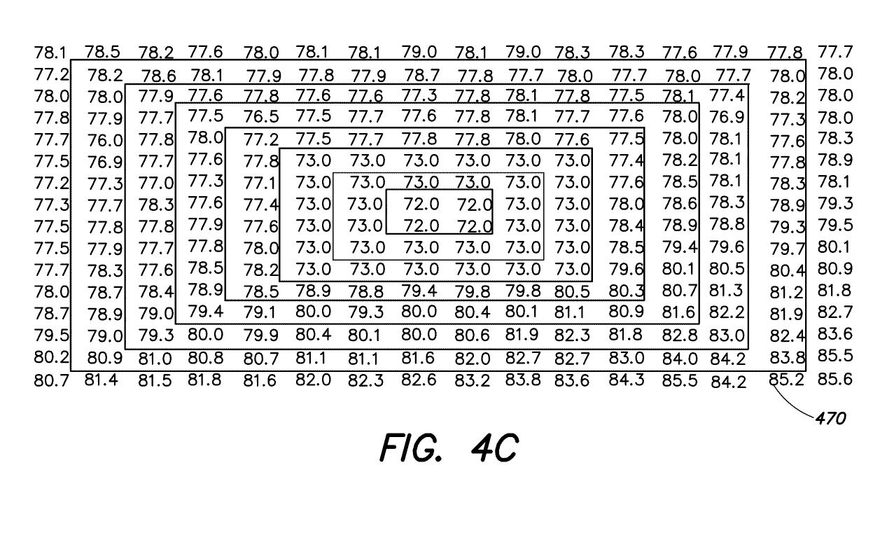

In one embodiment, a number of files are transmitted for analysis and/or archival. The number of files can vary depending on the information being transmitted. For example, a thermal image file, a visual light digital image file, and a text version of the thermal image data can be communicated as individual files. In another example, patient information can also be transmitted in a separate file for later analysis. In some settings, the individual files can be stored together in larger files and in other settings the individual files can be broken into smaller files to facilitate transmission. In one embodiment, two files are transmitted for analysis and/or archiving: a visual light digital image paired with a grayscale thermal image of the subject area in one file, and a text version of extracted temperature readings from the thermal image in the second file. Examples of data text files are illustrated in FIGS. 4A, 4B and 4C, discussed in greater detail below. In the examples, the text file is an ASCII representation of the thermal image data. One should appreciate that many file formats may be used for the storage and transmission of the image data, as well as the patient's historical and present data. The files in any one embodiment can be combined or broken into smaller files. In another example, only one copy of each image is transmitted, however upon review, the thermal image data may be displayed in conjunction with grayscale and/or color images of the subject area. In another example, the thermal image data may be displayed in conjunction with a visual light image of the subject area. Further, the thermal image can be stored and transmitted using a grayscale color palette. In some embodiments, a visual light image is transmitted with a grayscale thermal image and a file containing thermal data values.

According to another aspect, the system detects abnormal variation in temperature associated with the eruption and/or development of a wound. In one example, the system detects variation in temperature associated with the development of pressure ulcers. A pressure ulcer is localized injury to the skin and/or underlying tissue usually over a bony prominence that typically occurs as a result of pressure, or pressure in combination with shear and/or friction. Pressure ulcers are wounds that develop as a result of blood flow being restricted to an area of the body over a bony prominence due to unrelieved pressure for a period of time. Once the affected tissue becomes necrotic, blood flow is further restricted to that area. In particular, pressure ulcers are known to most likely occur in regions over “bony prominences” or cartilaginous areas of the body that are under pressure, often because of lack of mobility and/or sensation in those areas.

In one example a system incorporates the following features:
A unique exam number throughout the system regardless of exam type.
A unique identifier that correlates the imaging device used, the image scan type, the technician performing the scan, the facility and the patient.
Exam specific questionnaires which provide pertinent data for automated risk potential calculations.
Medical image collection system. Cameras, software, and remote image storage.
Remote automated routing of medical image data to an appropriate interpreter (e.g., specialist) for interpretation.
Remote automated delivery of interpreted medical image data to an appropriate facility.
Statistical analysis of collected image data correlated to exam questionnaires to provide more accurate automated potential risk indicators.
Automated electronic billing to facilities based on image captures and remote interpretations.

One aspect of the present invention addresses, specifically, how to collect and archive medical data associated with a particular patient without attaching identifying personal information. The system archives medical image data utilizing a bar-coding system which correlates the collection device, the facility where the imaging was performed, and a unique patient ID which may or may not correlate to a real person. This system therefore supports “anonymous” imaging while maintaining an archive of data for statistical analysis.

In accordance with one aspect of the current invention, it is recognized that exam specific questionnaires provide key information regarding the current physical status of the patient to be examined and historical insight into the patient's lifestyle or hereditary predispositions. This data archival from the questionnaires allows for a continually updated automatic risk calculator to more accurately provide early detection of potential health hazards.

In accordance with another aspect of the present invention, an image capture system operates only with a valid unique server thermal exam ID. The thermal exam ID must verify the camera device for the image collection to occur. After the unique exam ID is accepted, the image collection device runs the appropriate test based on the server generated ID. The system permits a technician to request that questionnaires and/or images either be interpreted or not. The resulting files (images, history, and indicator data) are transferred to a Thermal Medical Imaging (TMI) server.

In accordance with yet another aspect of the present invention, it is realized that the medical image file(s) may require interpretation. The medical image file may, based on its unique exam ID, be placed into a queue of an appropriate interpreter and a notice of its placement in the queue transmitted (e.g., by email, text message, etc.) to the interpreter. The interpreter may then access a web portal to gain access to the specific medical image data. Once the interpreter has completed their interpretation, a report submitted by the interpreter may be uploaded to the server.

In accordance with one aspect of the current invention, an uploaded exam interpretation which has not yet been delivered to the originating facility of the doctor with responsibility for the patient will automatically generate a message (e.g., an email or text message) to the facility or doctor. The facility or doctor can then log into the web portal and access the interpretation results. The presence of exam results can be indicated in a number of ways, including e-mail, page, text message, instant message, and an automated voice indicator, among other options. The presence of exam results which have yet to be accessed by the doctor may also be periodically monitored by the system. Also, the act of uploading may trigger a process that executes a notification protocol.

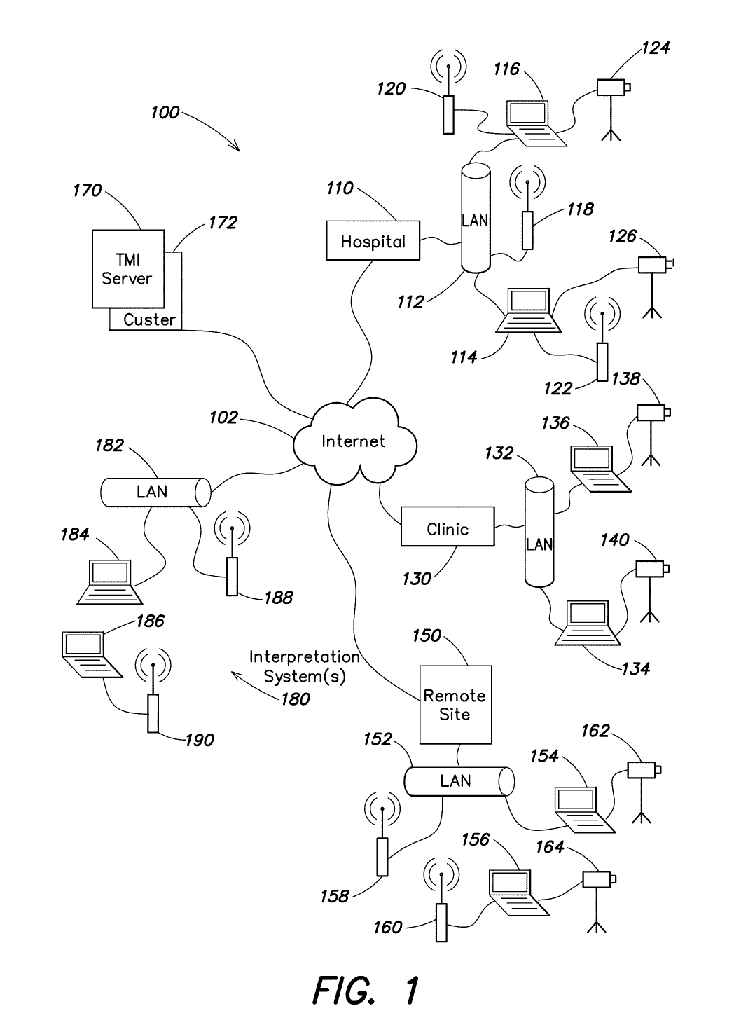

Shown in FIG. 1 is an example of a system architecture. System 100 includes a TMI (Thermal Medical Imaging) server 170 connected to a communication network, which may include links through the Internet 102. The TMI server 170 can be a stand-alone server or may be one of a cluster of servers 172. The TMI server 170 can also be configured in a client/server relationship or can be configured as a distributed computer system. One should appreciate that the particular configuration of the computer system (TMI server) may take many forms, and should not be limited to the implementation shown in the example of FIG. 1.

The TMI server 170 generates unique IDs to be used with capturing image data from actual patients. By using a unique ID, the system is able to anonymously archive medical image data without associating that data to a particular patient. In some embodiments, the unique ID identifies a facility, an imaging device, a technician, a clinic, a hospital, and/or other remote site. The unique ID may also be identify a fictitious patient or may be associated with a real patient. Identification of the locations, systems, and personnel can assist in anonymous information acquisition by providing information not associated with a patient that permits for system maintenance and process review. For example, equipment that is underperforming or not meeting specification can be readily identified. Optionally, quality information can be maintained with respect to personnel operating the equipment.

Hospitals 110, clinics 130, or remote sites 150 may be connected to the TMI server 170 through the world wide web or FTP portal, for example, at 102. The communication architecture within the various sites may take many forms including a wireless network (e.g., wireless access points 118 or 158 coupled with wireless communication devices 120, 122, 160), wired LAN architecture 112, 132, 152, or may include dial up, or other communication architectures. Within the hospital 110, clinic 130, or remote sites 150, a facility exists for capturing thermal medical information. In one example, a thermal imaging camera 124, 138, 162, or 164 is connected to a laptop 116, 136, 154 or 156. One should appreciate that the thermal imaging camera may be connected to any general-purpose computer that is capable of transmitting the image data captured during an exam, for example, camera desktop computer pairs 126 and 114 and 140 and 134. Any general-purpose computer, including any laptop, may also be adapted to accept technician input regarding patient history and/or present symptoms that may indicate at risk characteristics.

In one embodiment, the thermal imaging camera 124 or 126 is a handheld device that a technician operates by taking pictures of predetermined areas of a patient's body. In the context of pressure ulcer detection, specific areas are known to be vulnerable or likely positions of outbreak. In one example, the exam involves capturing thermal images and visual light digital images of those areas. Cameras 124, 126, 138, 140, and 162 can be configured to capture thermal images as well as visual light images. In one embodiment, another camera can be used to capture visual light images in conjunction with the thermal cameras. In another example, the technician captures images from the “bony prominences” or cartilaginous areas of the body that may be under pressure. The camera can be held six inches from the patient in order to capture the desired region. In another embodiment, the technician positions the camera and a stand or other camera mounting device is used to maintain the camera's position relative to the patient.

According to another embodiment, a camera can be positioned at a distance of 24-36 inches from the patient in order to capture the desired region. Fixed or automated cameras may also be used. Such embodiments may include a mechanism for moving the patient and/or the camera to achieve a predetermined distance from the desired picture area. For example, the patient may rest upon a mechanical bed that slides, rotates, and/or elevates to permit images of desired areas to be captured. In another example, a camera may be configured to rotate, slide, and/or elevate to capture images of desired areas. The example of six inches as a distance from the camera to the subject area may be different in different implementations. In one alternative, a distance of 24-36 inches may be used. Moreover, statistical analysis may be used to generate appropriate distances. In other examples, configurations of the thermal image and/or visual image device can dictate the appropriate distance from camera to imaged area. In certain embodiments, target areas may be of different sizes, requiring different distances from the subject. In one example, a data file representing a 6″×6″ square on the target area will then be used to determine if a pattern of injury has been detected. In another embodiment, a 3″×3″ area is imaged.

The captured image data is uploaded to the TMI server 170. In one embodiment, questionnaire data is input in conjunction with the thermal image exam, and the questionnaire data is also uploaded to the TMI server. In another embodiment, questionnaire data is input in conjunction with the thermal image exam on the TMI server, and is associated with the corresponding exam data. However, the input of questionnaire data may take place separately from the thermal exam, and the invention should not be limited to any order of performing an exam and capturing questionnaire data. In one example, questionnaire data includes the patient's medical history, and/or present symptoms, but may also include additional information such as physical activity, lifestyle, diet, etc. Additionally, known methods such as the Braden Scale scoring system may also be used in conjunction with data gathering and image acquisition to generate additional pertinent information. In some embodiments, patient information acquisition and thermal examination is conducted as part of a patient admission process. The patient admission process allows caregivers to establish at the time of admission that an injury or a potential for injury exists for a specific patient. This early detection permits, among other options, early treatment for detected injuries that may not be visible to the naked eye. In some settings, thermal examination can be made part of any patient admission process, but may be particularly suited to long term care settings.

In one example, a technician uploading the image and questionnaire data may request interpretation of the uploaded data. In response to such a request, the TMI server 170 may generate an interpretation request and put the request into an interpretation queue accessed on interpretation systems 184 and 186. Interpretation systems 184 and 186 can be directly connected to the TMI server 170 or as shown, can be connected to the TMI server 170 through a communication network, e.g., Internet 102. Interpretation system 180 can also be connected to local networks 182 via wired or wireless connections (e.g., wireless access point 188 and wireless communication device 190). The interpretation request may also be the result of automated processing by the TMI server of uploaded data. In particular, temperature variations in a particular thermal image may indicate a high risk of wound eruption. In one example, temperature variation in a particular image may indicate a high risk of pressure ulcer development, and further medical evaluation may be required to confirm the automated indicators. One should realize that automated indicators may be sufficient alone to identify a potential for eruption and/or development, however, medical practice requirements may require that a medical professional confirm such a diagnosis. Thus, according to one embodiment, an automated analysis generates an interpretation request in response to identified risk factors. In another embodiment, automated analysis may generate a diagnosis on the basis of the identified risk factors.

In one example, a temperature variation is calculated from captured thermal data of a desired area of a subject. The temperature variation within the subject area is then analyzed against statistical data regarding wound outbreak and/or development. In one example, a temperature variation over a distance is used to determine if a potential for eruption and/or wound development exists. In one embodiment, temperature variation over distance may be used to generate an automated request for interpretation. In another embodiment, temperature variation over distance may be used to generate an automated diagnosis.

Requests for interpretation may be flagged for review or may generate notification to appropriate interpreters. Such notifications may be sent as text messages, pages, e-mails, automated voice calls, instant messages, etc. An interpreter (e.g., a medical specialist) accesses the TMI server in order to review interpretation requests. The interpreter reviews the collected data and either independently generates an interpretation report or confirms the indications identified by the system. The interpretation report is then transmitted to the TMI server, and the originating site (e.g., Clinic, Hospital, or Remote Site) can gain access to the report. The clinic, hospital, or remote site may receive a notification that an interpretation report exists. The clinic, hospital, and/or remote site may log into the TMI server and retrieve the results.

According to another aspect, the data (e.g., image files and historical information) may be archived on the TMI server for further analysis. Statistical information obtained from the archived data may be used to refine, fine-tune, and/or confirm various thresholds used to identify risk characteristics. In one embodiment, temperature variation over distance is analyzed to establish new ranges for risk characteristics and to establish the present ranges are correct.

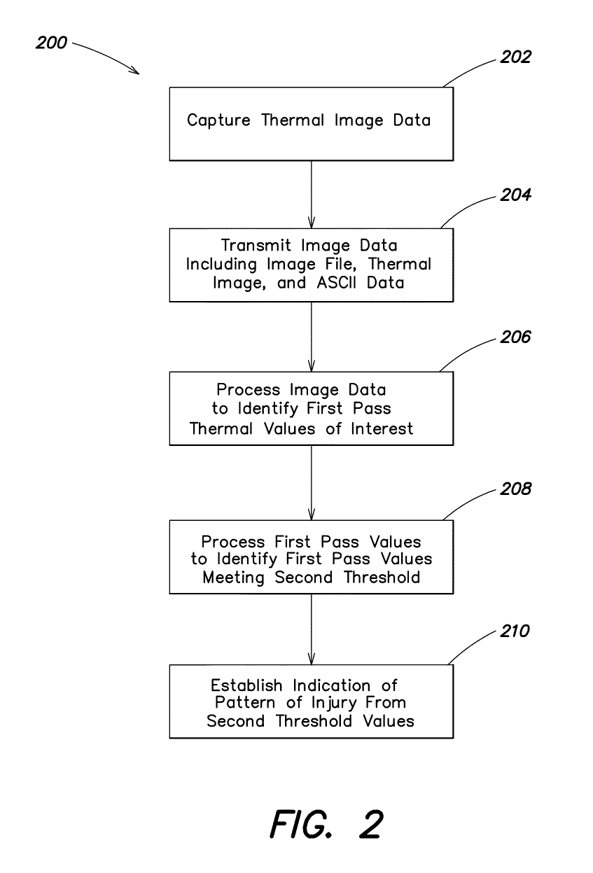

Shown in FIG. 2 is an example process 200 for establishing an indication of a pattern of injury from thermal image data. Process 200 begins with the capture of image data at 202 of an area of interest. According to one example, image capture includes generation of a standard visual image in conjunction with a thermal image on an image capture device, such as a thermal imaging camera. An example visual image can be a color image, a grayscale image, or a visual light image of another format. A thermal image can be a color image or a grayscale image. Although one should appreciate that other image formats can be used for both the visual light image and/or the thermal image.

To improve the thermal data acquired, additional processes may take place prior to imaging a subject. In one example, the area of interest on the subject is relieved from pressure for a minimum of three minutes prior to thermal imaging. Any area of interest can be off-loaded by positioning the subject so as to relieve any pressure on the area of interest. Other time periods can be used to assist in capturing accurate readings. Longer or shorter periods may be used to allow an area of interest to acclimate to ambient temperature.

The visual image can be captured using a digital visual image capture device, such as a conventional camera, however, other devices for capturing visual images can be employed. In some examples, a single image capture device is configured to capture both visual images and thermal images. Captured images can be stored and transmitted directly from an image capture device, such as a camera. In some examples, the image capture device can be connected to a general-purpose computer system, either wirelessly or via a wired connection. Image data can be transmitted to the general-purpose computer system configured for image storage. A general-purpose computer system may include additional functions, for example, for processing the image data to establish thermal data values. The thermal data values can be stored in a number of formats including, for example, ASCII data values. Thermal data values can be processed and stored in a data map form. In some example data maps, the data values are positioned within the map to reflect a distance from a center point.

The general-purpose computer can be configured to receive images from other sources. For example, a scanned image can be transmitted and processed by the general-purpose computer system to obtain data values representative of the thermal image. In some embodiments, the image capture device prepares data values, and generates a separate file for the values, although the data values can also be included in a thermal image or visual image. The thermal image and the underlying values represented in the thermal image can also be processed in other formats, for example, as a heat map, topographical display, three dimensional representation, or other format suitable for diagnostic review.

In one example, the thermal data values (e.g., ASCII data values) are arranged based on their proximity to a point of interest. A data map of thermal values is then displayed based on the distance of the thermal data value from the point of interest. The point of interest is typically a bony prominence. During image capture at 202, an image capture device is typically centered on a bony prominence and images are taken. In one example, the image capture device is configured for processing captured image data and the ASCII data values are generated within the image capture device. In another example, the image capture device is operatively connected to a general-purpose computer that generates the ASCII data values. In some other embodiments, the image capture device is connected to a distributed computing platform. It should be appreciated that image processing can be performed over any number of connected computer systems.

In some settings, the images captured by the thermal image device are processed either in the thermal image device itself or an attached computer system. Processing can translate the captured image data into temperature values that can be used in identifying a pattern of injury. For example, the captured image data can be filtered to obtain the temperature values. In one embodiment, the thermal image is generated by assigning a color to a specific temperature reading within a specific range. The thermal image or the visual depiction of the data values shows a graphical representation of the objective data values. Although an image can appear different by assigning different color palettes, the captured temperature reading or data point remains the same for any visual rendering of the temperature values.

At step 204, the image data (e.g., visual image and thermal image) is transmitted to thermal medical image system. Typically, the thermal data values (ASCII or otherwise) are also transmitted with the image files, however, in some embodiments, image processing can be performed after the image files are transmitted to obtain data values.

The image files can be compressed and/or stored in various formats. In one example, a thermal image can be stored as a grayscale image. In a grayscale thermal image, the gradation between black and white can be used to represent temperature variation in the image. In some embodiments, white is used to represent hot areas, and black is used to represent cooler areas. A standard visual image file can include more information than is necessary for establishing an indication of a pattern of injury, including information on areas surrounding the point of interest. According to some embodiments, the data values and the maps generated from them are limited to the areas more proximate to the point of interest.

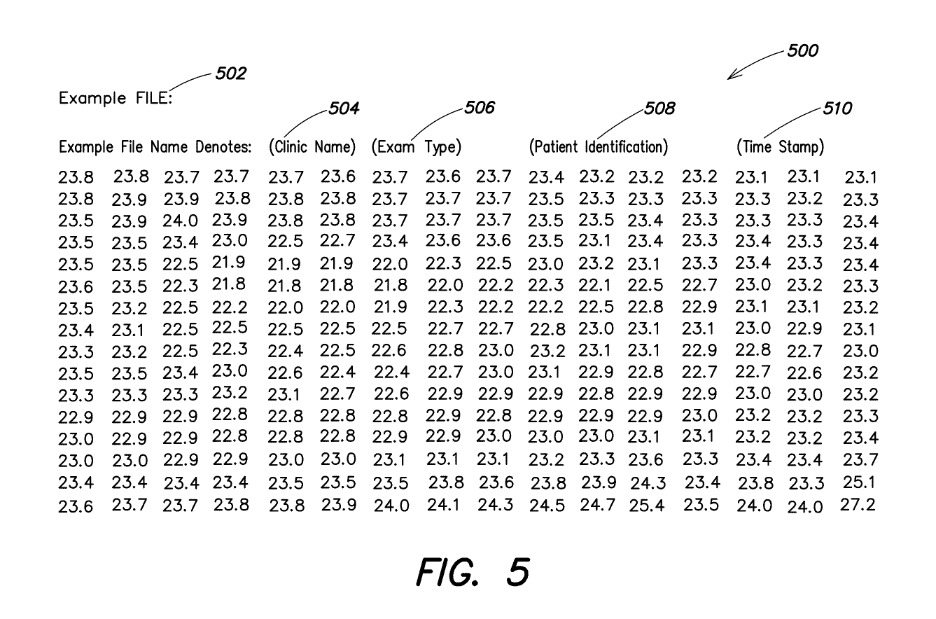

As discussed, the data maps can be generated after image capture or alternatively can be generated during image capture or in conjunction with image capture. In a typical example, a 16 by 16 data map is generated of the area surrounding a point of interest with each of the data values representing a known distance from the point of interest. According to one embodiment, the data map is configured to group data values of the same distance. In one example, data rings or boundaries are provided within the data map, with each data ring representing the same distance from the point of interest. Subsequent rings represent a distance further away from the point of interest relative to interior rings. Typically, each ring or group is representative of a known distance, although different values may be used for the distance metric. FIG. 5 illustrates one example of a file including a data map of thermal image values. The image file 500 includes an image file name 502 that encodes information regarding a clinic name 504, an exam type 506, a patient identifier 508 and a time stamp 510. This information can be used to identify, for example, clinics having a particularly high incidence of pressure ulcers. In other examples, this information permits tracking and reporting on malfunctioning systems, and can also permit tracking of technician performance in using the system.

At 206, the image data is received at a thermal medical image server and the data is processed to establish a first set of values that satisfy a predetermined threshold. In one example, an inner matrix is extracted from a received data map to identify the innermost 8 by 8 temperature readings. Alternatively, extraction of the inner data values can occur prior to transmission, for example, on the image capture device, or on a general-purpose computer system or other computing platform connected to an image capture device that together perform step 202. First pass data values are identified in the 8 by 8 matrix by comparing each individual data value against the remaining 63 values in the data map. For each value that differs by more than 1.5 degrees Celsius, when compared to any of the remaining 63 values, that value is determined to satisfy the first pass threshold. Other statistical methods can be employed to identify temperature readings that may be considered to have a statistically significant variation in temperature. Other approaches can include calculating a greater than 1.5 degree difference in the maximum and minimum temperature with a sample, calculating a greater than 1.5 degree difference from the 75^{th} percentile (of data values) and minimum with one sample, and calculating a greater that 1.5 degree difference in the mean and minimum in one sample.

Shown by way of example is Table I which illustrates an extracted 8 by 8 matrix of temperature values. Each value shown in Table I satisfies the first pass threshold. Other thresholds may be applied to extracted temperature values. Additionally, processing can be performed against the entire data map, rather than an extracted portion. In a typical embodiment, processing occurs with respect to an inner most matrix of temperature values.

TABLE I

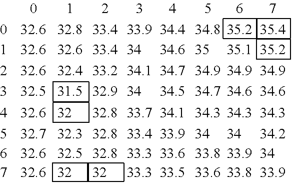

For data values meeting the first pass threshold, further processing is performed. In some embodiments, the identification of first pass values triggers an automated message to an administrator. The automated message includes an indication that a pattern of injury may exist, and further review of the thermal image, visual image and data values is warranted. The first pass data values can also be reported in the automated message. The automated message may also include the image files themselves.

Further processing of the first pass values occurs at 208. For each first pass value, a mean is calculated for the remaining 63 values in the 8 by 8 matrix. The first pass value(s) are compared to the mean to determine if a second threshold is satisfied. Any value satisfying the second threshold is flagged as a second pass value. The second threshold can be different than or the same as the first pass threshold. In one example, each first pass value is compared against the mean of the remaining 63 values to determine if a difference of 1.5 degrees is exceeded. Indicated in Table I (outlined box) are seven data values within the matrix that satisfy the second threshold. The mean values and temperature difference calculations are provided by way of example in Table II. One should appreciate that different thresholds can be applied against the first pass values to establish the data values that meet the second threshold. In some embodiments, all of the remaining data values in the 8 by 8 matrix are used when calculating the mean for comparison.

TABLE II

| Row | Col | Value | Mean | Difference |
|---|---|---|---|---|
| 0 | 6 | 35.2 | 33.609523809524 | 1.5904761904762 |
| 0 | 7 | 35.4 | 33.606349206349 | 1.7936507936508 |
| 1 | 7 | 35.2 | 33.609523809524 | 1.5904761904762 |
| 3 | 1 | 31.5 | 33.668253968254 | 2.168253968254 |
| 4 | 1 | 32.0 | 33.660317460317 | 1.6603174603175 |
| 7 | 1 | 32.0 | 33.660317460317 | 1.6603174603175 |
| 7 | 2 | 32.0 | 33.660317460317 | 1.6603174603175 |

At 210, an indication of a pattern of injury is established by the data values that satisfy both the first pass threshold and the second threshold. In some embodiments, the identification of values that meet the second threshold triggers an automated message to an administrator. The automated message includes an indication that a pattern of injury may exist, and further review of the thermal image, visual image and data values is warranted. The first pass data values and/or second pass data values can also be reported in the automated message. Further, the automated message can also include the image files themselves, for example, as attachments. In some embodiments, links to the relevant data are provided rather than including the underlying data itself.

The step of establishing a pattern of injury can also include reporting on a maximum difference contained within the second pass data values. In some embodiments, the reporting can provide a correlation between the maximum difference and a probability that a pattern of injury exists. In other embodiments, a minimum difference can be used. And in still others, an average difference value for the second pass values can be reported. In some alternatives, all or some of the difference calculations can be provided to a reviewing entity. Typically, a doctor, physician, nurse practitioner, or other medical professional can be engaged to review the indication of a pattern of injury. The review can include diagnosis and further can include inspection of the visual image, thermal image, associated data values, and the calculations performed on the data.

### Example Diagnostic Cycle

According to one aspect of the present invention, a diagnostic system and methodology is provided for acquiring thermal image data and diagnosing a potential for wound outbreak on a patient based on the acquired thermal image data and detection of a pattern of injury.

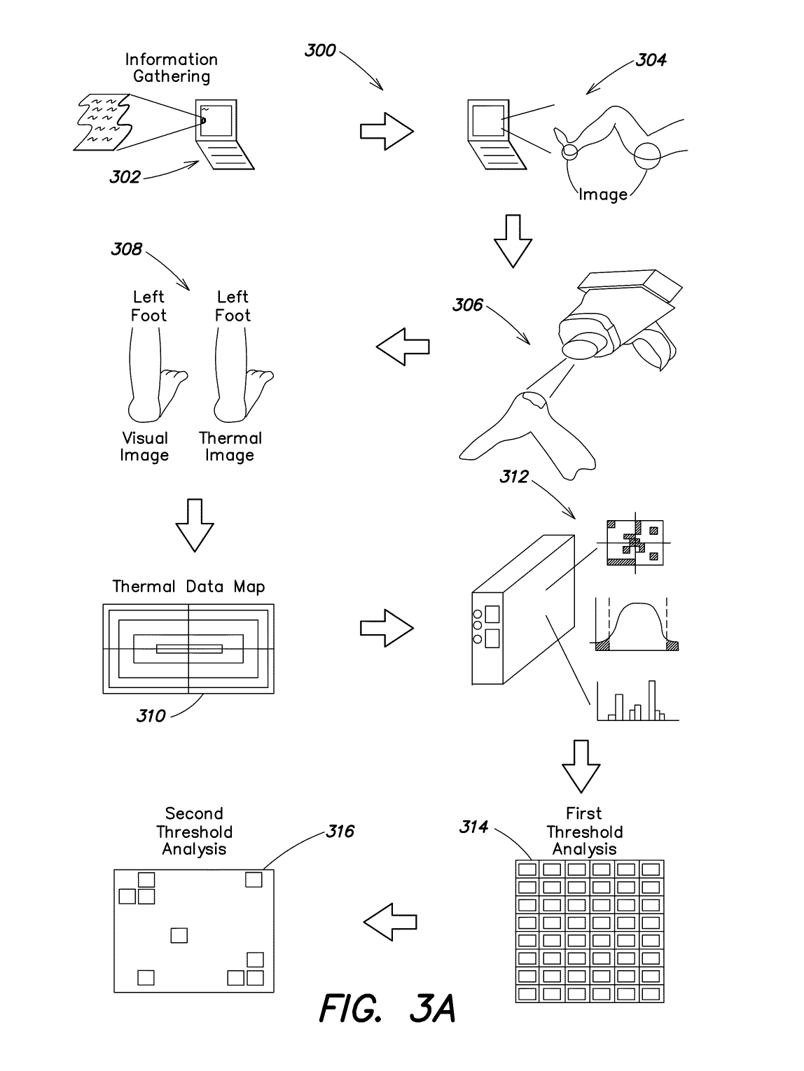

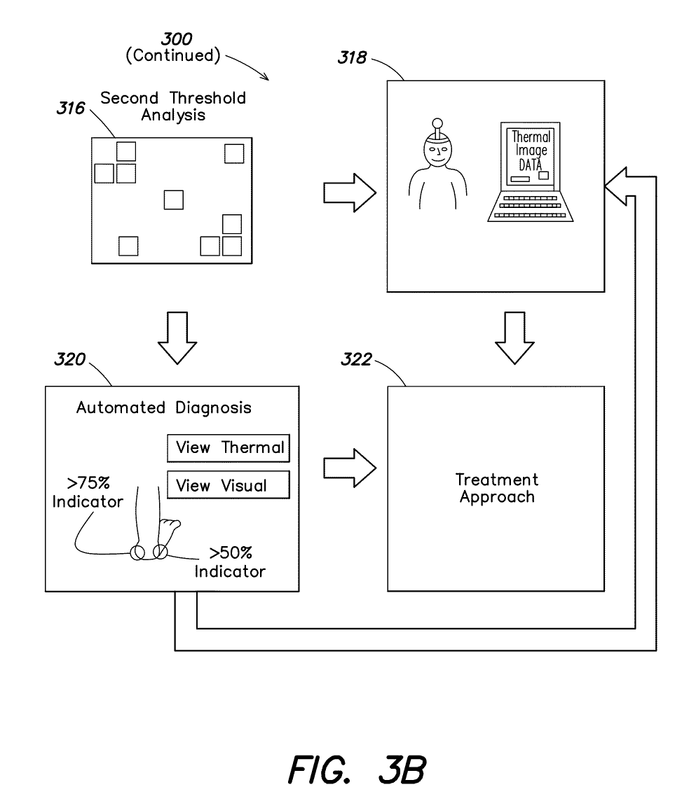

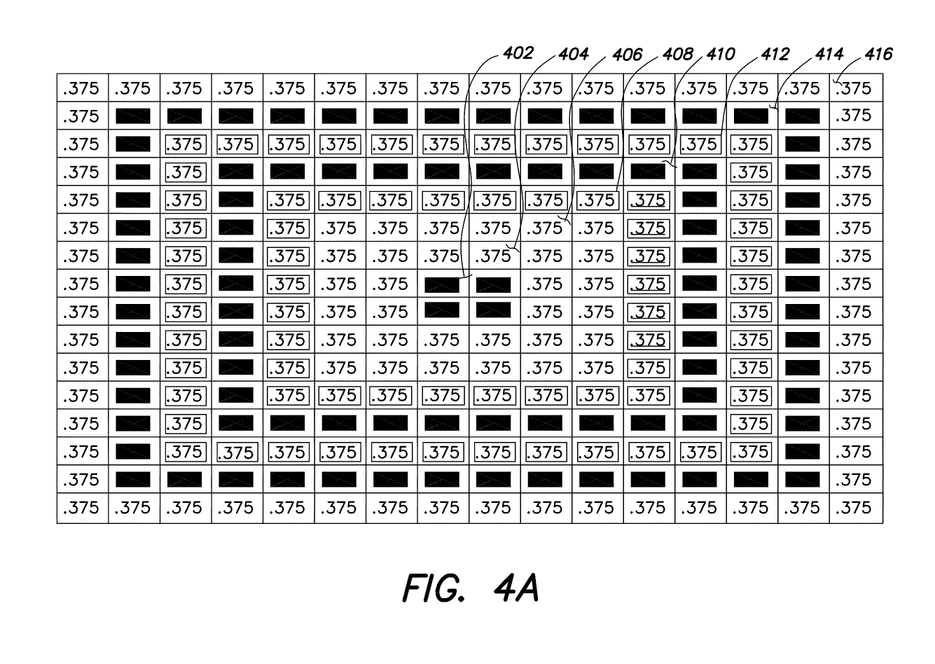

In one embodiment, an acquisition and diagnostic cycle begins with a patient at a clinic or other diagnostic facility. A technician operates an image capture device (e.g., a digital camera) to acquire thermal image data of areas of interest. Areas of interest can be identified for each patient based in part on information acquired during patient interviews. As shown in FIG. 3, one example process 300 includes an information gathering step at 302. The information gathering step can occur, for example, using existing patient medical history and/or during a patient interview. The existing information can be used in combination with information acquired during an interview process. Patient interviews can occur before, during, or after an image acquisition session. In one alternative, patient information can be captured directly from a patient's chart or medical history.

In some embodiments, a patient questionnaire is employed to gather information pertaining to potential wound outbreak and/or pressure ulcer development. The gathered information, including any information gathered during a patient interview and/or information from a patient questionnaire can assist in the identification of an area of interest on the patient. In particular, bony prominences are identified in conjunction with likely areas of wound eruption. In some examples, the bony prominences that are proximate to areas that may be under pressure are identified for a particular patient. In other examples, particular bony prominences can be imaged as a routine matter. For example, bony prominences around the feet and sacrum can be imaged as part of a continuous monitoring process even if information acquisition does not specifically call for imaging of those areas.

For patients of limited or reduced mobility, likely areas of wound eruption can be identified based on the areas of the patient's body subject to pressure. For example, a patient who presents with reduced mobility and rests most often in a lateral reclined position will most likely develop injury or the potential for injury at bony prominences located on the patient's side. Some example areas for potential injury include the patient's hip, elbow, and shoulder. Other example areas for potential injury include along the patients leg, at the ankle, and along the foot.

Identification of the potential areas of injury provides an advantage in the image acquisition process by reducing the locations needed to be reviewed for diagnosis. The technician performing the image acquisition can be directed by an image capture computer system to the areas that should be imaged at, for example, 304. For example, the patient questionnaire can be input into a computer system which, based on the information provided, determines areas that should be imaged during the image acquisition session. For settings in which a patient interview is conducted, the patient's responses can be input into a computer system, which can perform the analysis itself or communicate the interview information to a diagnostic system, which can subsequently provide for direction to a technician regarding locations to image during an image capture session. Alternatively, a physician or other medical professional can direct the technician to image specific areas based on their review of the patient and/or patient information. One should readily appreciate that the more information provided and analyzed in determining potential injury areas improves the diagnostic procedure, and the invention should not be read as limited to any particular type of information gathered or to specific information provided by way of example.

Once a technician knows the areas of interest to image, the technician can operate a digital camera (having thermal capture capability) to generate thermal images of the identified areas. In some examples, the technician insures that any area of interest is not subject to pressure prior to imaging the area. In one embodiment, the technician insures that the area to be imaged is not under pressure for a minimum period of time so the area of interest acclimates to ambient temperate.

According to one approach, the technician then captures a thermal image and a visual light image of the area of interest at 306. The visual light image can assist medical professionals in diagnostic review of the captured image data, and may be, for example, a color or grayscale visual light image. In some examples, the acquisition process provides a physician with a color visual image of the subject area in addition to the thermal image of the same area. The image capture device employed by the technician can be configured for easy manipulation. For example, handheld digital cameras are easily positioned along a patient's body, permitting imaging of multiple discrete areas that can be located at opposite ends of the patient's body. In some embodiments, the camera can be configured to project a border around an area of interest on the patient's body to assist in image capture. In other embodiments, the camera can be configured to project cross hairs to assist the technician in centering the camera on the area of interest.

The camera can also be configured to capture and produce two image files, one a standard visual light image file and the other a thermal image file, for example, at 308. The camera can generate the images on the camera itself or be connected to additional computer systems that store and/or process image data received from the camera. In some examples, two cameras can be used, one to capture a thermal image and a second camera to capture a visual light image. According to one embodiment, captured thermal data is also processed into a thermal data map of the area of interest, where thermal data values are captured and located on the map according to their distance from the center of the captured image. Various distances can be used when establishing a temperature map. In one example thermal data map at 310, each boundary represents a ⅜ inch increment in distance from the center point of the area or interest.

Another example data map is illustrated in FIG. 4A. As shown, the inner most 4 values at 402 map temperature readings located ⅜ of an inch or 0.375 inches from the center of the image area. The positions surrounding those four values 404 (12 positions) define the next distance boundary of ⅜ of an inch. The data positions of like color at 406 (20 positions), 408 (28 positions), 410 (36 positions), 412 (44 positions), 414 (52 positions) and 416 (60 positions) each represent a distance increment of ⅜ of an inch. FIG. 4B, illustrates actual temperature readings arranged in an example data file. The result of the analysis of the temperature data displayed in the file at 450 indicates a normal temperature pattern. FIG. 4C illustrates temperature readings that indicate a pattern of injury and can be correlated to a probability of wound eruption or outbreak. The thermal image data is displayed in a positional mapping at 470.

Returning to FIG. 3 and process 300, the captured thermal image data is communicated to a thermal image processing system. The thermal image processing system can be separate from the image capture device, any computer system attached to the image capture device, or can be located on the image capture device and/or attached computer system. Typically, the acquired image data is communicated to a secure processing server, which analyzes the thermal data to identify significant temperature readings. The analysis of the thermal data can include identification of an inner most section of data values when measured from the center of the area of interest. In one example, the section of data values corresponding to inner 8 by 8 section of the thermal data map is analyzed at 312. Each of the data values corresponding to the 8 by 8 section is analyzed against the remaining values to identify the thermal data values that satisfy a first threshold for significance at 314.

The number of the inner most values analyzed can be selected to achieve different processing requirements, and can also be adjusted in conjunction with adjustments of the distance metric used for mapping the data values. For example, if 1/10 inch was used to define boundaries in the thermal data map, one could analyze thermal data corresponding to a 10 by 10 section of the data map. In addition, larger sections of acquired image data can be analyzed. In some embodiments, analysis occurs against all of the thermal data captured during image acquisition. In other embodiments, the center of the mapped data can be adjusted based analysis of the image data. For example, a computer system and/or the image capture device can correct for any skew introduced during the image acquisition by adjusting the center position of the data map. Adjustments can occur in conjunction with identification of the inner analysis area.

In one example, evaluation of the data proceeds by comparing individual data values against the remaining data values. A first threshold comparison identifies values of significance. For example, significance can be determined based on a difference in temperature greater than a specific threshold when any two data values in the data map are compared. In one embodiment, the threshold requires a difference in temperature of 1.5 degrees. In other embodiments, other thresholds can be used, including, for example, 2 degrees, 2.5 degrees among others. Historical data may also be used to assist in determining any requirement of a first threshold to evaluate the thermal data. A patient with thermal data in their medical histories may have an established correlation and/or indicator of wound eruption based on thermal data values of a known difference which can be used in setting the first threshold for that patient. A first threshold is typically established so as to identify outlier temperature values.

On a bell-curve distribution of the temperature values, the first threshold could be set at a point that identifies values on the outer edges of the distribution. Additional processes can be employed to refine any established threshold, and in some examples, thermal image data is collected and analyzed for a large number of patients. For that patient population, the collected thermal data is analyzed against any eruptions that actually occur, and a correlation between wound eruption and temperature readings can be established for use in dynamically refining a first threshold indicator.

Once thermal values have been identified as meeting a first threshold the diagnostic cycle proceeds with further analysis at 316 to identify data values that meet a second threshold. In one example, each data value in an analyzed thermal data map is analyzed against a mean of the remaining values. For the data analyzed as an 8 by 8 section, each data value is analyzed against the mean of the remaining 63 values. A temperature difference is calculated between the data values and the mean value. For data values that exceed a threshold difference, those data values are flagged as second threshold values. Shown at 316 are example data values that have been determined to meet a second threshold of 1.5 degrees (difference from mean). Data values that meet the second threshold can be referred to as second pass data values. Other thresholds can be used to identify second pass data values, for example, a 2 degree difference may be required, or an even greater temperature variation may be required to satisfy the second threshold. In some settings, a smaller temperature difference is required.

One should appreciate, that it is expected that the greater the deviation detected in a thermal image the greater the likelihood that ulcer development will occur. Thus, it is further expected that the use of a 2 degree difference for the second threshold will establish a greater degree of probability that a wound will erupt than the use of a 1.5 degree temperature difference for the second threshold. Once second pass data values have been identified, the system has established that a pattern of injury exists for the patient and can further provide information for localizing the pattern of injury on the individual patient. Knowing locations at risk allows clinical staff to better target intervention/treatment and provides significant advantage over known systems like the Braden Scale.

Identification of second pass data values can also trigger a message to an interpreter. In a typical setting a medical professional is required to diagnose a patient. Accordingly, the system is configured to alert an interpreter to evaluate the result of the thermal image analysis. At 318 an interpreter reviews the processed thermal image data. The thermal image data can be presented to the interpreter showing the data values that meet the first threshold. The thermal image data can further be presented to the interpreter showing the data values that meet the second threshold. Based on the image data, an interpreter can recommend a treatment approach at 322. The treatment approach can take into account thermal data that did not meet the first and second thresholds. For example, areas on that do not indicate a pattern of injury (do not meet the first and second threshold) may be preferred when positioning a patient to relieve pressure from areas on the patient's body to do that indicate a pattern of injury. Other treatment options may be warranted and implemented at the direction of an interpreter or other medical professional.

In one example, the message to an interpreter includes a notification that patient data needs to be interpreted. The interpreter can then log into a secure system to access the patient's data. In some examples, the patient's data may include patient history, visual light images of areas of interest and any thermal images of the areas of interest. The interpreter can access a visual display of the thermal data values. The visual display of thermal data values can include the data map analyzed by the system and can include other representations of the thermal data. The system can be configured to automatically generate an e-mail to an interpreter in response to the identification of second pass values. The message can include, for example, a hyperlink to a secure server, which can be accessed to retrieve image data associated with a patient. In some alternatives, the image data can be attached, embedded or included in a message to an interpreter to facilitate review.

In one embodiment, the interpreter provides their analysis to another medical professional at a clinic or facility housing the patient. In one example, an attending physician can be notified of the result of an interpretation of the thermal image data. The system can be configured to provide interpreter recommendations for treatment to the medical profession responsible for patient's care. In some settings, the system can further identify a probability of wound eruption in addition to the identification of a pattern of injury.

The system can also perform diagnostic review of the image data at 320 and provide such diagnostic information to either an interpreter for review at 318 or the system can provide such information directly to medical professional at 322 to be used in a treatment approach. It is possible to configure the system to provide treatment recommendations based on the analyzed data, and further such recommendations can be reviewed by an interpreter at 318 or by an attending physician or other medical professional at 322. However, in a typical environment diagnosis is reserved for medical professionals. The system can be further configured to provide displays on the acquired visual light image for a patient of the presence of indicators that correlate to a specific probability of wound eruption. For example, second pass data values can be identified on a visual display of the area of interest, so that an interpreter or other reviewing physician can access a visual display of the thermal analysis.

In some embodiments, a process for acquiring and analyzing thermal data can proceed differently that discussed above with respect to process 300. The steps of image acquisition can be followed by an interpretation request, where an interpreter reviews the image data and any analysis in conjunction with the system's review of first pass data values and/or second pass data values, providing medical professional oversight over each step or the end result of the analysis. In some settings, an interpreter can be required to sign off on the system review of the acquired information.

Example process 300 can be implemented as part of a patient intake process. The patient intake process can couple the acquisition of patient information, the registration of the patient for admission, and any thermal examination of the patient. Establishing earlier indication of existing injury, visualized or not, and establishing early indication of potential injury provides significant advantage in patient care, both for administration and for treatment.

### Data Acquisition

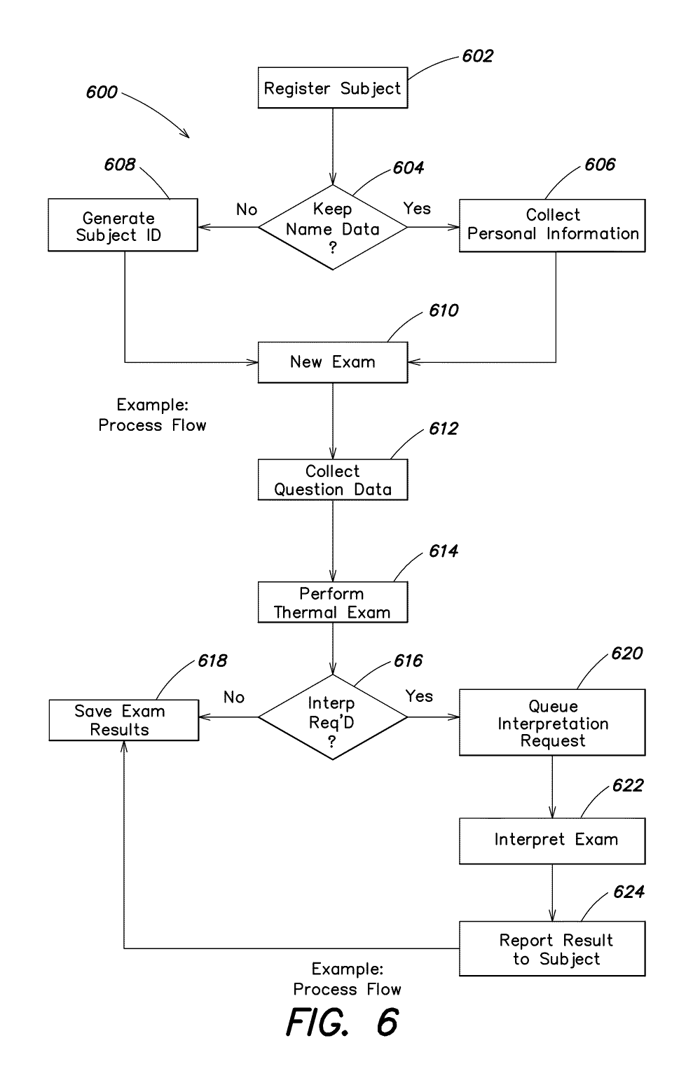

According to another aspect the method and systems support anonymous acquisition and storage of patient related information. For example, FIG. 6 illustrates an example process for acquiring information and thermal data while supporting anonymous acquisition. Example process 600 begins with the registration of a subject at 602. The subject is typically a patient undergoing a thermal examination, however, other subjects may be used and registration of other persons and/or things may occur during system diagnostics and testing. Typically registration proceeds by accessing a user interface displayed on a computer system. The user interface prompts a user, for example, a technician, to enter patient information at 606, if name and other patient data will be kept, 604 Yes, the patient information entered is stored in association with the thermal examination information. If patient data should remain anonymous, 604 No, the user interface can generate a request for a subject identifier. In one example, a subject identifier request is transmitted to a computer server, e.g., a TMI server. In response to the subject identifier request a new subject identifier is generated at 608. In one alternative an existing subject identifier may be matched to the subject and the existing subject identifier returned in response to a request for the subject identifier. Process 600 continues at 610 with the creation of a new examination record.

At 612, information is collected from the subject in response to questions that can be presented to the technician at the user interface, or can be entered into appropriate fields in the user interface based on answers to questions given by the subject. In one example, the subject can respond to paper-based questionnaires and a technician can enter responsive information in the user interface. In another example, the technician may interview the subject and input answers directly. Other methods for obtaining information can also be used and can combine paper records, subject's medical histories (electronic or paper format), and interview(s), among other sources. One example can include review by the technician of the subject's medical history to obtain information responsive to system information fields displayed in the user interface. Automated review of existing patient data can also extract information, for example, from available medical histories.

At 614, the technician starts the thermal examination of the subject. According to one example, thermal examination involves capturing thermal image information for identified areas of interest. Certain areas of a subject body can be identified for constant monitoring. For example, the subject's feet and sacrum may be places in which the subject is most likely to develop pressure ulcers and, therefore, periodic imaging of those areas is appropriate even in the absence of the characteristics of a pattern of injury. The data collected at 612 can also influence the identification of areas of interest. For example, subject activity level, positioning, and at rest positioning can be used to assist in the determination of the location of an area of interest. Visual light images can also be captured in conjunction with thermal image acquisition. Visual light images can be used in performing analysis of the subject and can assist in the determination of a pattern of injury.

Once the technician has imaged any places of interest, the image data is transferred to the server for storing the image data. The technician may request that interpretation of the acquired data be performed at 616 Yes. In one alternative, the server can automatically analyze the received data to determine if any interpretation should be performed. In another, the technician can determine that no interpretation is required. Typically, a determination that no review is required is reserved for medical personnel and the user interface can be configured to require confirmation of the user's credentials. In one example, the system will request interpretation by default absent a confirmed user indicating that interpretation is not required. If no interpretation is required, 616 No, the results of the examination and any acquired data are saved to the server at 618. Where interpretation is requested by the server or by the user, 616 Yes, an interpretation request is entered into a processing queue at 620. The processing queue can be resident on interpretation systems or can be resident on a central server computer system.

Interpretation systems can be used to access the queue via a remote process individually or as a batch process. Alternatively, the server can distribute and/or manage the distribution of the items in the queue to various connected interpretation systems. In one example, a medical professional with sufficient expertise to review and analyze thermal image data access an interpretation request on an interpretation system. Such an interpretation system can be a general-purpose computer system operatively connected to the server on which thermal image data is stored. In some settings, the connection between the interpretation system(s) and the server includes a secure connection over the Internet. Although one should appreciate that various configurations can be employed to permit communication between a server housing subject thermal image data and an interpretation system on which a qualified medical professional can evaluate the subject thermal image data.

Interpretation of the stored image data occurs at 622. The interpretation can include review of any data analysis performed by the server and/or stored on the server regarding the thermal image data. In some examples, the server contains three files: a visual light image file; a thermal image file; and a thermal data value file all of which can be delivered to an interpretation system. In additional, any information collected on the subject can also be accessed at the interpretation system for review. According to one example, the thermal data value file is arranged in a data map which organizes the thermal data values based on a position relative to the center of a captured image area. Values within the data map can be highlighted to indicate whether or not they meet a first threshold, and can be further highlighted to indicate whether or not they meet a second threshold, as discussed above. In addition, the data values can also include a visual indicator correlated to a degree of temperature difference. For example, temperature values exceeding a 1.5 degree difference from a mean of the remaining data values may be shown in one color, and temperature values with a difference of 2 degrees shown in another. Various legends and indicators can be displayed with the image data to alert the interpreter to the significance of the highlighted temperature values. In one example, a message window can display to the interpreter a probability of outbreak associated with the presence of a particular data value meeting first and second thresholds. In another example, a message window can indicate the presence of a pattern of injury. Once an examination has been interpreted at 622, the results of the examination can be reported to the subject at 624 either directly or to an attending physician who reports the information to the subject. Any interpretation can be stored as part of the examination results at 618. The various steps of the example process 600 have been described for purposes of illustration, and variations on data acquisition processes are contemplated. The illustrated steps can be performed in different order, and not all steps need be performed as part of a data acquisition process. The reporting of results to the subject at 624, for example, can be omitted and/or performed as part of a different process, among other options.

### Communication Flow

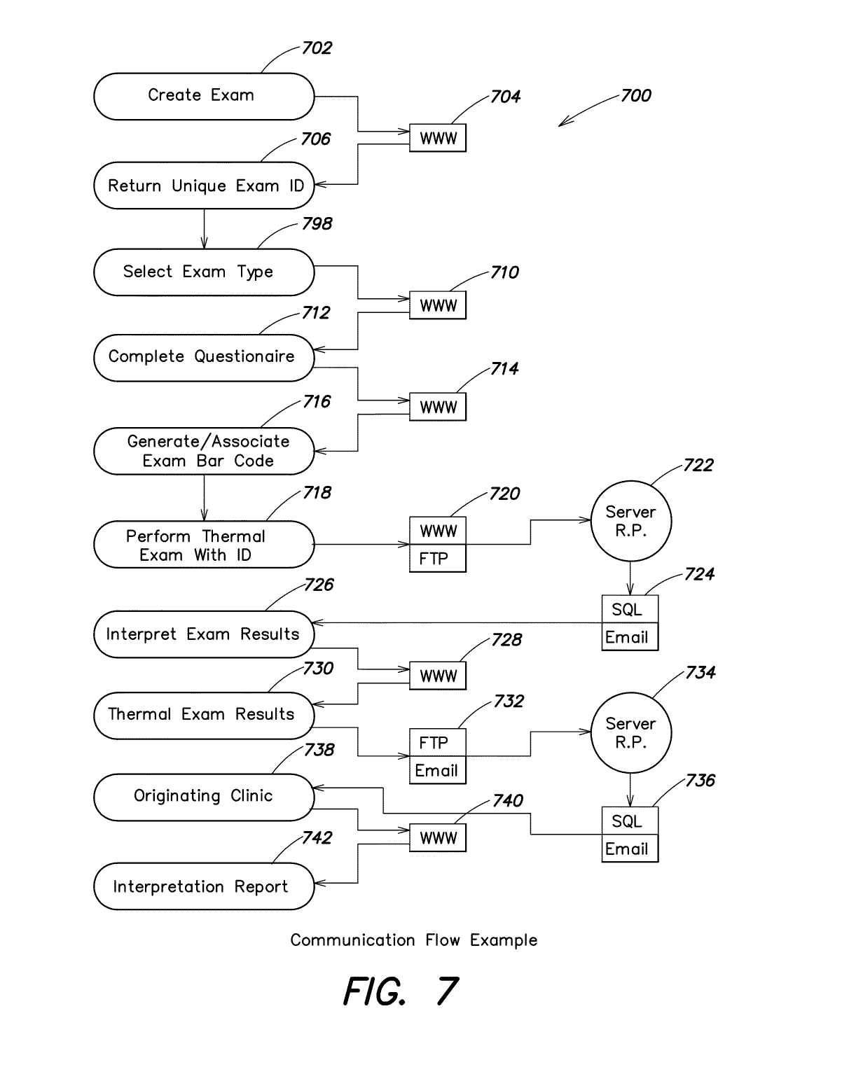

According to one aspect, various computer systems can be configured to implement operations that support and/or perform data acquisition associated with a subject, support and/or perform thermal examination, and support and/or perform interpretation of thermal image data. Shown in FIG. 7 is an example of communication flow 700 between host computer systems and a server system. Although multiple computer systems and servers can be implemented on either side of the illustrated communications, process 700 is illustrated from the perspective of individual host computer systems that communicate over a communication network to a server system. One should appreciate that any number of host computer systems are also contemplated as well as multiple server systems that separately or together can support and manage thermal image acquisition and interpretation.

Example process 700 starts with a user at a host computer establishing communication with a server system. The user can be, for example, a technician or other medical professional. In one example, the user is a certified operator of thermal imaging camera. At 702 the technician submits a request for a new examination record in a user interface displayed on a host computer system. In one example, the user interface is rendered on the host computer system from information sent by a server process, and any data input into the user interface is communicated over the Internet to the server system. For example, the technician can select a submit option in the user interface that triggers the transmission of information to the server. In other examples, the user interface can be dynamic and transmit input information automatically. In other embodiments, the user interface can be local to the host computer system and the host computer system can trigger communication protocols to the server system at various data entry points and/or upon user selection of new screens.

In one interface example, rendered pages can include a continue button, that when selected provides access to another screen display. The selection of the continue button can also be configured to communicate/post any data entered at the time of selection to the server. In another example, the technician can select a submit option in the user interface to trigger the transmission of information.

A request for a new exam is communicated at 704 over a communication network to a server that returns a unique examination identifier to the host computer at 706. The communication can be formatted in any one of the communication protocols configured for use on the Internet. For example, the communication can be in the form of TCP/IP data packets, or can be in other communication formats. The communication channel established between the host and server can be secure, for example, using https protocols and can include the use of a virtual private network (VPN) connections. In some implementations, all communications are encrypted for transmission.

At 708, the user interface prompts the technician to select an examination type. The response can be communicated to the server at 710 which responds with a questionnaire appropriate for the examination type. In other embodiments, questionnaires associated with the various examination types can be downloaded to the host computer and accessed locally upon selection of the examination type. In one example, a thermal exam is selected by the technician and the technician enters information to complete the questionnaire at 712. According to some embodiments, the questionnaire includes questions regarding a subject's medical history. The questions can cover diet, activity level, mobility issues among other options. The information input in response to the questions is communicated to the server at 714.

The server upon receiving a request to create a new examination record generates a unique examination identifier. The server can also be configured to generate an examination bar code in association with the unique examination identifier. In one alternative, the server can associate an existing bar code with the unique examination identifier, for example, where the subject has existing examination records.

The server identifies and/or creates the bar code to use with a particular examination request, associates the bar code with the examination record and transmits the bar code to the host computer at 716. At 718, the technician is directed to perform a thermal examination through the user interface. The results of the thermal examination, and in particular image data files, are transmitted to the server at 720. As discussed herein, a thermal examination of a subject can include generation of a visual light image and a thermal image of an area of interest on the subject. These image files can be transmitted via an ftp process, individually or in batch, although one should appreciate that other protocols can be employed including secure protocols such as ssh, scp and can include use of a website secured by https protocols. In one embodiment, the user interface prompts the technician to upload images to the server from any image device. In another embodiment, the images device(s) can be configured to store any image files on the host computer, and the upload can proceed from the host computer.

At 722, a server reporting process is invoked that places a request for interpretation of the received examination information into an interpretation queue. For example, the interpretation queue can involve a SQL process that generates an automated e-mail message to an interpreter at 724. Other queuing processes can be implemented to request interpretation of examination data. For example, a text message, page, or automated phone call can be placed to an interpreter. In one example, the interpretation request notifies the interpreter that the request exists. Some embodiments include information in the message on accessing the information to interpret, for example, hyperlinks to the image data and subject information. In one alternative, an interpretation request can include the examination data itself.

As discussed, an interpretation request is received by an interpreter in response to an automatic message generated at 724. At 726, the interpreter receives a request to interpret exam results. The interpreter can access any stored examination information using an interpretation system, typically a host computer system connected to the Internet. For example, the interpreter can log into a web page to gain secure access to information stored on the server at 728. At 730, the interpreter is able to access the examination information on a web page displayed on the host computer system and generate any interpretation for the examination data. The thermal examination result, diagnosis, and/or notes generated by the interpreter at 730 can be transmitted to the server through the same connection at 732. In another example, the interpreter can download the examination information, review the information, and provide examination results for the thermal examination information in a subsequent communication at 732.

Examination results which can include interpreted image files can be transmitted via an ftp process at 732 over the Internet. Any information or notes generated by the interpreter can accompany the image data itself or can be transmitted separately. At 734, a server response process identifies that interpretation results have been received at the server system and a delivery process is invoked at 736 to transmit the interpretation results to an originating clinic at 738. The delivery process can include accessing information stored in a database using, for example, a SQL process that generates an automated message or notification to a physician at the originating clinic at 738. In one example, an authorized user at the clinic can access a web page at 740 to receive access to an interpretation report at 742. In some implementations, review of the interpretation report involves multiple communications between a host and server system as the examination report is reviewed. Each page of the report can require communication of data between the server and host. Alternatively, the entire report could be downloaded to the host and accessed locally. One should appreciate that communication of information illustrated in process 700 may occur over multiple transmissions in a communication session for each step illustrated and that the illustration is not intended to be limited to individual communications for each step. The host and server can be configured to request and deliver portions of content and subsequent communications can deliver additional portions as needed. The example process 700 illustrates access to external server(s) hosting thermal image data, although one should appreciate that the communication process illustrated is readily adapted to other settings, including, for example, an internal network or intranet.

### Tracking and Analysis

According to one aspect, thermal image data and/or interpreted information stored on server systems can be used in post acquisition tracking and analysis. For example, statistical models for detecting patterns of injury can be modified and created based on the storage and analysis of thermal image data over time. The analysis can also be coupled with actual observations of injury and/or ulcer development for particular subjects. Initial models that identify a pattern of injury for a particular subject thermal can be confirmed against subsequent analysis of the same subject. Alternatively, the efficacy of treatment options can be compared for subjects with similar patterns of injury to determine whether a specific treatment option should be preferred. Tracking thermal information and analysis can also assist in refining the thresholds used in determining whether a pattern of injury exists, and can be used to refine calculations for determining a probability of ulcer development based on an identified pattern of injury.

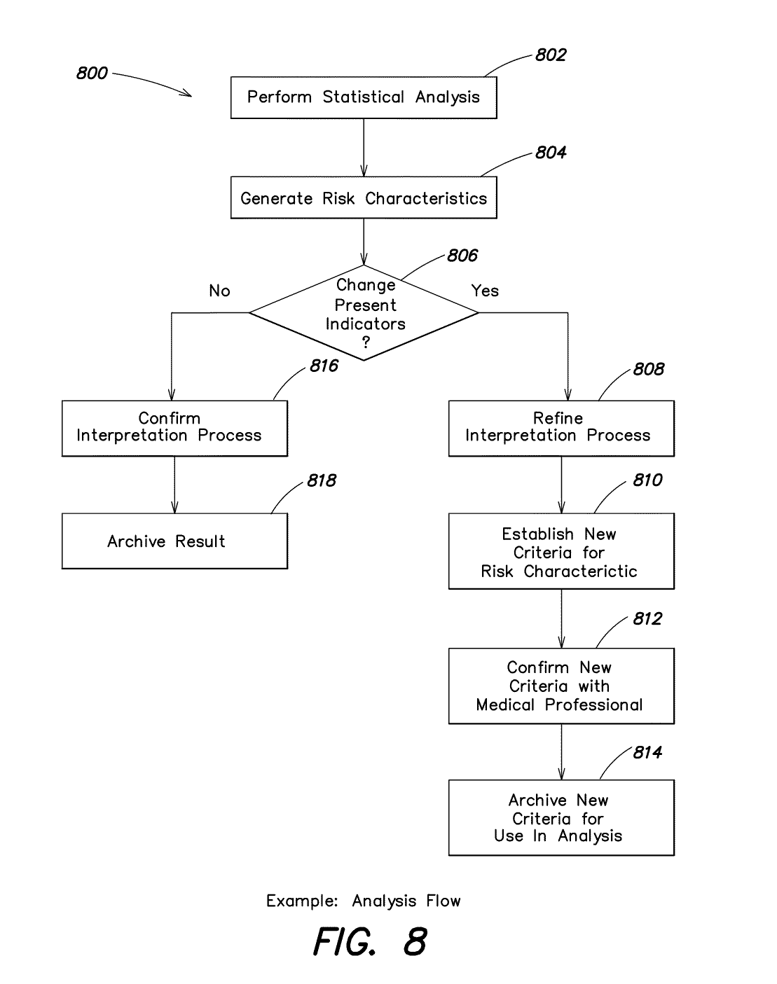

Shown in FIG. 8 is an example process 800 for developing and refining statistical models for detecting patterns of injury. Process 800 can be employed to confirm or refine criteria used in identification of a pattern of injury. Process 800 beings with statistical analysis of stored thermal image data at 802. The analysis of stored data can be used to generate risk characteristics for further analysis of thermal image data at 804. Additionally, existing risk characteristics can also be evaluated.

The statistical analysis can test potential correlation between the existence of specific thermal image patterns repeated throughout the stored thermal image data with a potential for ulcer development as measured against actual instances of ulcer development for those subjects. In one embodiment, specific temperature variations within a thermal image that are being used to identify a pattern of injury can be measured against observed outbreak data to confirm current interpretations processes.

By providing for tracking and analysis, large patient populations and large pools of tracked information can be reviewed to generate models for risk characteristics. Any correlation in such models can be confirmed or refined by tracking the subjects with the identified patterns to determine whether ulcer development occurred in a subject with the modeled risk characteristic. Based on the identified patterns and any subsequent wound development, risk characteristics are confirmed and/or generated for use in later analysis. Such tracking can result in a need to change indicators presently being employed. For example, at 806 Yes, statistical analysis may identify additional risk characteristics that are not currently being employed. The interpretation process can be refined at 808, and the additional risks characteristics incorporated into new criteria at 810.

In some settings any diagnostic process needs be confirmed with medical professionals. Clinical trials can be conducted under the supervision of medical professionals to confirm new criteria at 812. Additionally, any changed or additional criteria can be employed to reanalyze any stored data. The review of the stored data may demonstrate that the new criteria generates an accurate identification of patterns of injury without requiring clinical trials. Upon a determination and/or confirmation that the new criteria provides a better indicator of a pattern of injury, any new or additional criteria can be archived for use in analysis of thermal image data at 814.

At 806 No, tracked thermal image data can confirm that an interpretation process being used is appropriate at 816 and the result can be archived by the system at 818. For example, additional statistical analysis of data can provide a greater degree of confidence for the risk characteristics being modeled. The additional statistical analysis can be archived for subsequent use. The additional analysis may also provide a greater degree of certainty with respect to a correlation between an identified risk characteristic and a probability determination of actual wound eruption or ulcer development. Tracking this information over time provides additional diagnostic information that can be used, potentially, for any patient population.

In one example, a tracking system can generate and/or provide for any of the following information (or various combinations thereof) and can also do so while preserving patient anonymity:
Statistical analysis of actual outbreak on an analyzed patient
Confirm probability analysis of wound outbreak based on tracked data
Revise correlation statistics between temperature variance and probability of outbreak
Track efficacy of treatment, i.e. success or not in preventing wound outbreak after detection of pattern of injury
For previously analyzed patient—refine threshold values based on historical thermal data analysis
Refine probability of outbreak on a subject by subject basis
Refine treatment options on a subject by subject basis
Permits development of individualized indicators of pattern of injury for any given subject

By gathering and storing any and all of the data for analyzed subjects, including any data on a patient intake form, a TMI server can provide a warehouse of knowledge on pressure ulcer development and analysis. As the data can be stored anonymously any searches and analysis can be performed without implicating protected health information. Extensive studies can be performed to detect correlations on, or with any field in a subject intake form: age, sex, history, smoker, birth control, weight, ethnicity and other options including identification of specific ailments. Images and data can be captured using the same systems and procedures providing an extensive and consistent database of thermal imaging.

According to another aspect, tracking of thermal image data and generation of, for example, population statistics can be an effective tool in other areas of diagnosis. In one example, thermal image data can be used in supporting breast health. By measuring temperature differentials before and after therapeutic intervention, thermal/infrared evaluation can assist medical practitioners in monitoring cancer patients for prognostic outcome. Thermal imaging can be employed to determine tumor aggressiveness, and further can be combined with other imaging systems, mammography, ultrasound, MRI, or CT scanning to aid in any evaluation process. According to another aspect, thermal imaging can be used as a diagnostic tool for evaluation and identification of unresolved pain problems.

Various embodiments according to the present invention may be implemented on one or more computer systems. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor. It should be appreciated that one or more of any type computer system may be used to acquire thermal image data for a subject, acquire medical history information for the subject, manage storage of the information, including maintaining anonymity of acquired data, perform analysis on thermal image data, communicate and perform interpretations, and mange statistical modeling of stored data according to various embodiments of the invention. Further, the system may be located on a single computer or may be distributed among a plurality of computers attached by a communications network.

A general-purpose computer system according to one embodiment of the invention is configured to perform any of the described functions, including but not limited to establishing secure connection between image collection sites and thermal imaging servers, generating subject identifiers for use in image collection, capturing and storing thermal image data, identification of areas of interest, communicating thermal image files, generating thermal data mappings of temperature values, processing thermal image data against a first pass threshold, processing image data against a second pass threshold to identify patterns of injury, generating alerts to physicians regarding results of thermal data analysis, among other options. It should be appreciated, however, that the system may perform other functions, including displaying stored information so as to identify temperature values meeting the first threshold, temperature values meeting a second threshold, performing analysis on capture thermal data to generate statistic models for identifying patterns of injury, etc. Additional functions may also include managing visual light images in conjunction with thermal images of a subject, rendering user interfaces that direct user on the acquisition of thermal image data, encrypting any information, thermal or medical history, associated with the subject of a thermal examination, etc., and the invention is not limited to having any particular function or set of functions.

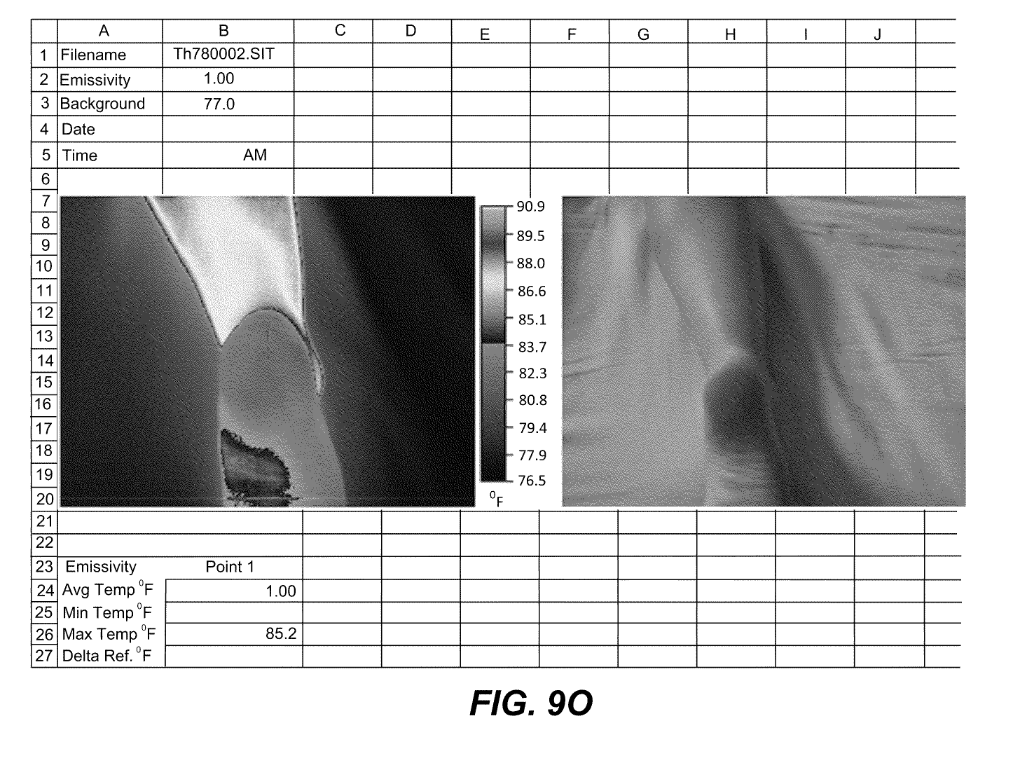

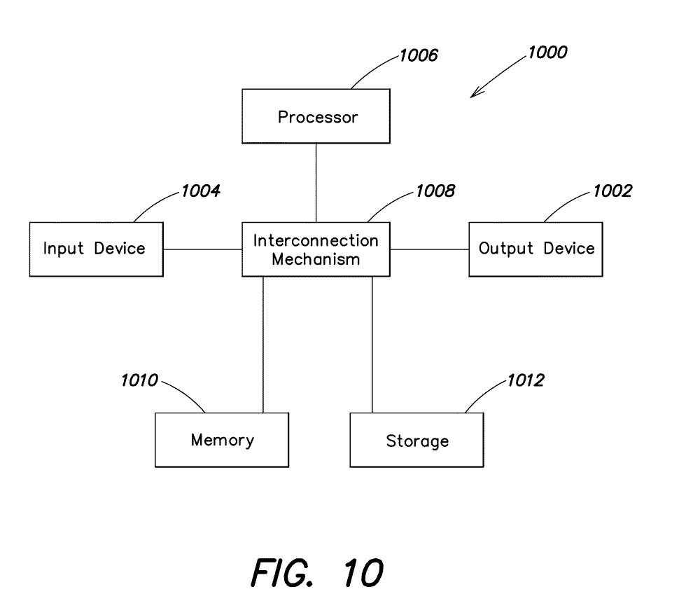

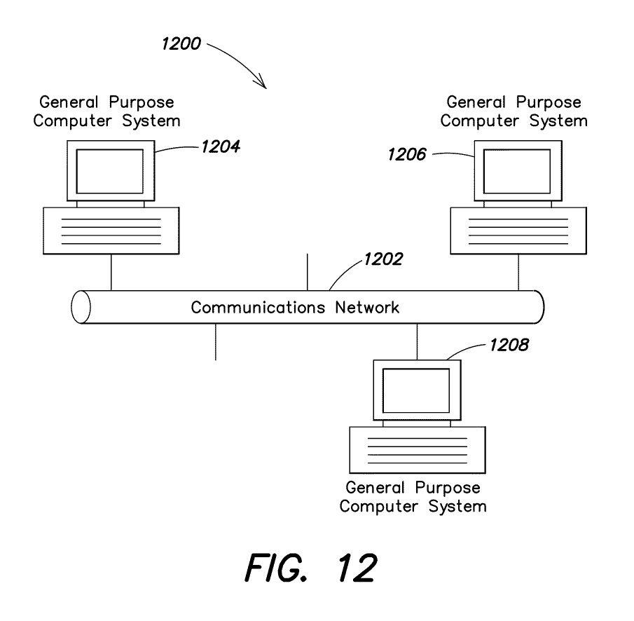

FIG. 10 shows a block diagram of a general-purpose computer system 1000 in which various aspects of the present invention may be practiced. For example, various aspects of the invention may be implemented as specialized software executing in one or more computer systems including general-purpose computer systems 1204, 1206, and 1208 communicating over network 1202 shown in FIG. 12. Computer system 1000 may include a processor 1006 connected to one or more memory devices 1010, such as a disk drive, memory, or other device for storing data. Memory 1010 is typically used for storing programs and data during operation of the computer system 1000. Components of computer system 1000 may be coupled by an interconnection mechanism 1008, which may include one or more busses (e.g., between components that are integrated within a same machine) and/or a network (e.g., between components that reside on separate discrete machines). The interconnection mechanism enables communications (e.g., data, instructions) to be exchanged between system components of system 1000.

Computer system 1000 may also include one or more input/output (I/O) devices 1004, for example, a keyboard, mouse, trackball, microphone, touch screen, a printing device, display screen, speaker, etc. Storage 1012, typically includes a computer readable and writeable nonvolatile recording medium in which signals are stored that define a program to be executed by the processor or information stored on or in the medium to be processed by the program.

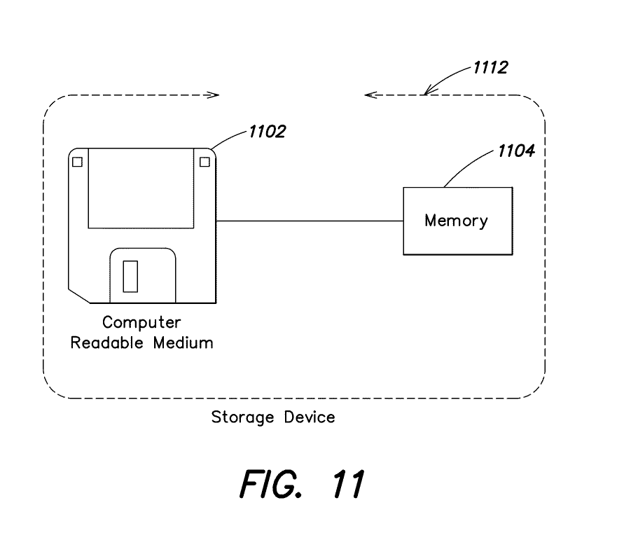

The medium may, for example, be a disk 1102 or flash memory as shown in FIG. 11. Typically, in operation, the processor causes data to be read from the nonvolatile recording medium into another memory 1104 that allows for faster access to the information by the processor than does the medium. This memory is typically a volatile, random access memory such as a dynamic random access memory (DRAM) or static memory (SRAM).

Referring again to FIG. 10, the memory may be located in storage 1012 as shown, or in memory system 1010. The processor 1006 generally manipulates the data within the memory 1010, and then copies the data to the medium associated with storage 1012 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Although computer system 1000 is shown by way of example as one type of computer system upon which various aspects of the invention may be practiced, it should be appreciated that aspects of the invention are not limited to being implemented on the computer system as shown in FIG. 10. Various aspects of the invention may be practiced on one or more computers having a different architectures or components than that shown in FIG. 10.

It should be appreciated that the invention is not limited to executing on any particular system or group of systems. Also, it should be appreciated that the invention is not limited to any particular distributed architecture, network, or communication protocol.

Various embodiments of the invention may be programmed using an object-oriented programming language, such as Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this invention can be implemented by one or more systems similar to system 1000. For instance, the system may be a distributed system (e.g., client server, multi-tier system) comprising multiple general-purpose computer systems. In one example, the system includes software processes executing on a system associated with user who captures thermal image data using a thermal imaging camera, an interpreter who reviews and analyzes thermal image data and medical history information for a subject, or a physician at treatment facility (e.g., a client computer system). These systems may permit the end users to access content in data locally or may permit remote access to content in data directly, the end users, for example, an interpreter may then edit the content to provide an interpretation of the thermal image data and medical history to provide a diagnosis regarding the existence of a pattern of injury, and the system permits the interpreter to upload the diagnosis and manages the distribution of such diagnosis to a physician responsible for care of the subject as discussed above, among other functions.

There may be other computer systems that perform functions such as capturing thermal image files, capturing visual image files, generating thermal data mappings, anonymous storage of subject data, automated detection of patterns of injury, requesting interpretation of acquired image data, data encryption, securing communication and perform various aspects of methods to identify patterns of injury from thermal data among other functions. These systems may be distributed among a communication system such as the Internet. One such distributed network, as discussed below with respect to FIG. 12, may be used to implement various aspects of the invention. FIG. 12 shows an architecture diagram of an example distributed system 1200 suitable for implementing various aspects of the invention. It should be appreciated that FIG. 12 is used for illustration purposes only, and that other architectures may be used to facilitate one or more aspects of the invention.

System 1200 may include one or more general-purpose computer systems distributed among a network 1202 such as, for example, the Internet. Such systems may cooperate to perform functions related to thermal image acquisition and analysis. In an example of one such system for identifying patterns of injury in thermal data, one or more users operate one or more client computer systems 1204, 1206, and 1208 through which thermal image files are acquired and communicated to a server system in order to analyze thermal data for patterns of injury. It should be understood that the one or more client computer systems 1204, 1206, and 1208 may also be used to access, for example, a request for interpretation and any associated subject information (thermal image files, visual image files, thermal data maps, and subject medical history) based on various aspects of the invention as well as enabling a physician to review any interpretation results generated. In one example, users interface with the system via an Internet-based interface.

In one example, a system 1204 includes a browser program such as the Microsoft Internet Explorer application program, Mozilla's FireFox, or Google's Chrome browser through which one or more websites may be accessed. Further, there may be one or more application programs that are executed on system 1204 that perform functions associated with acquiring and/or analyzing thermal image data. System 1204 may include one or more local databases including, but not limited to, thermal image data and subject medical history being reviewed.

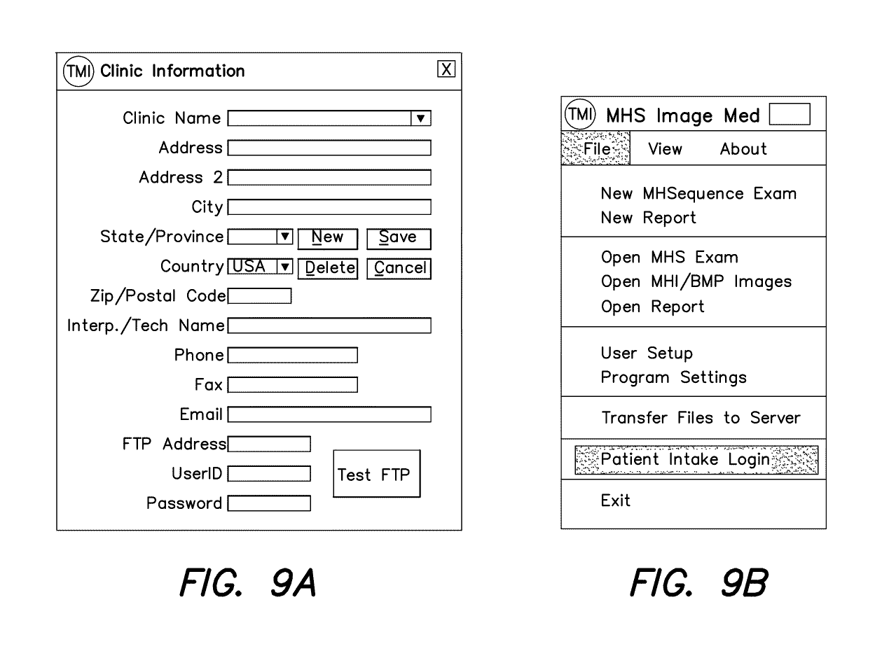

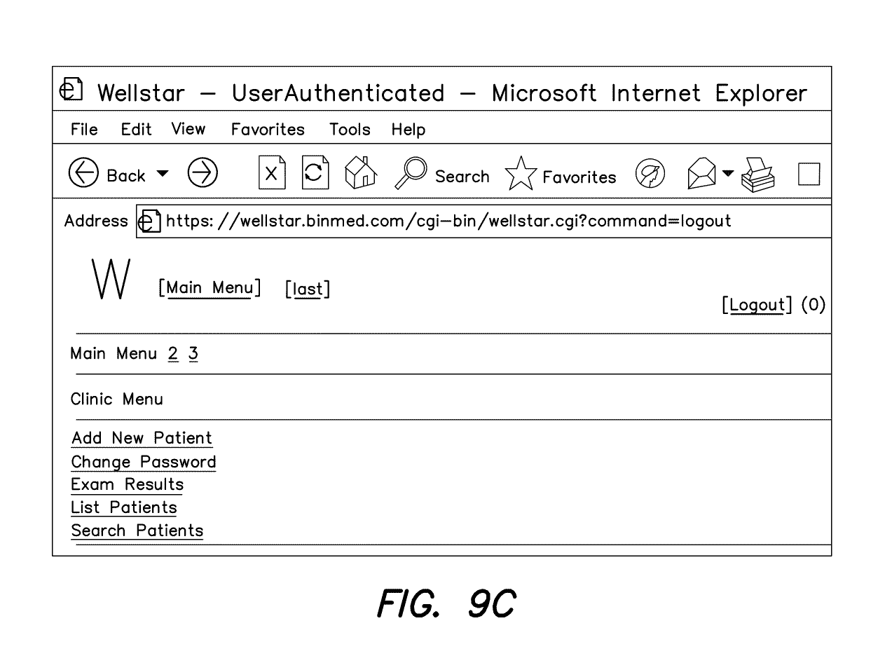

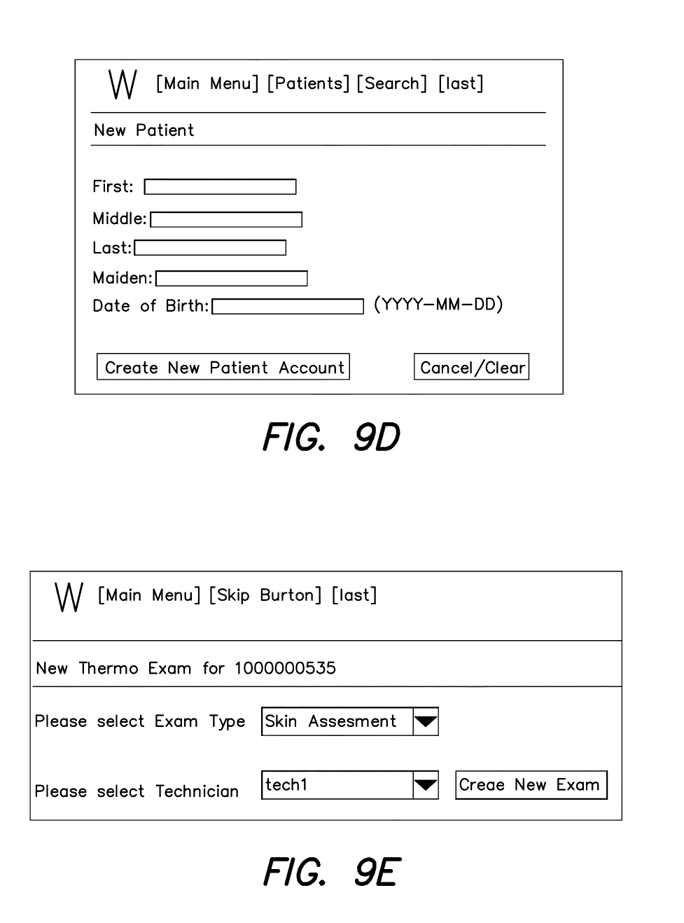

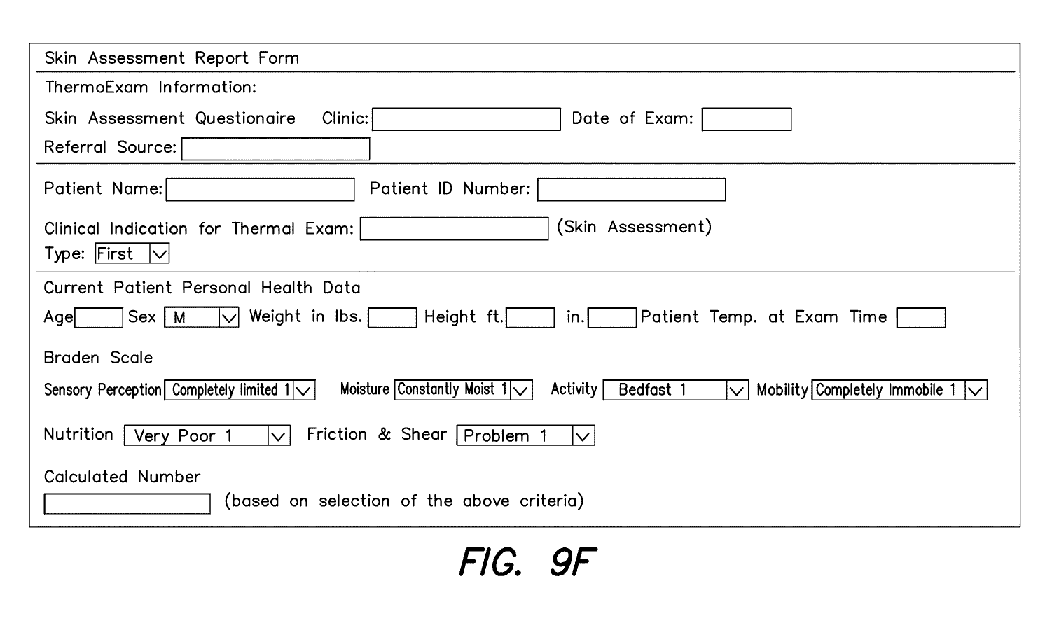

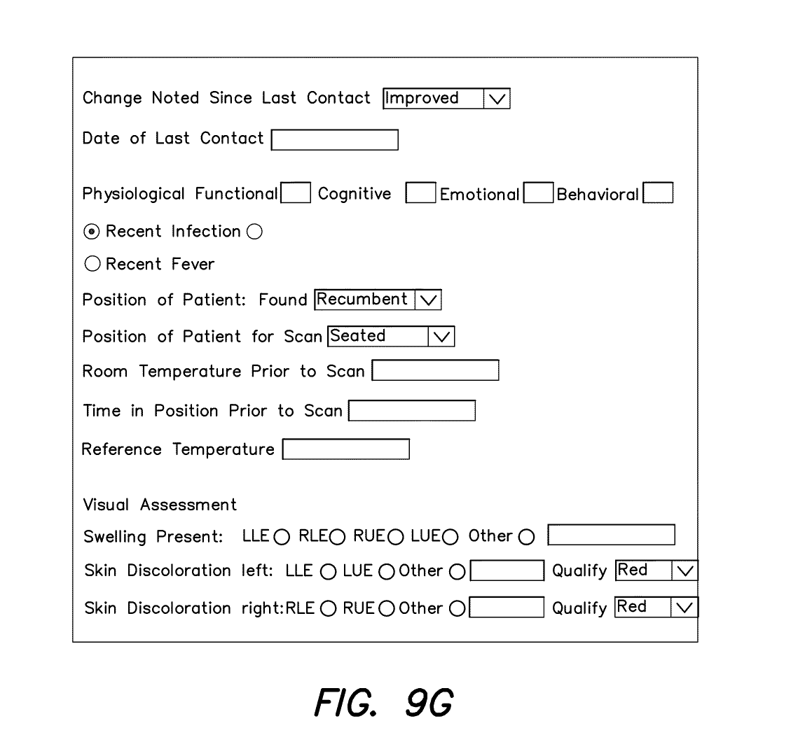

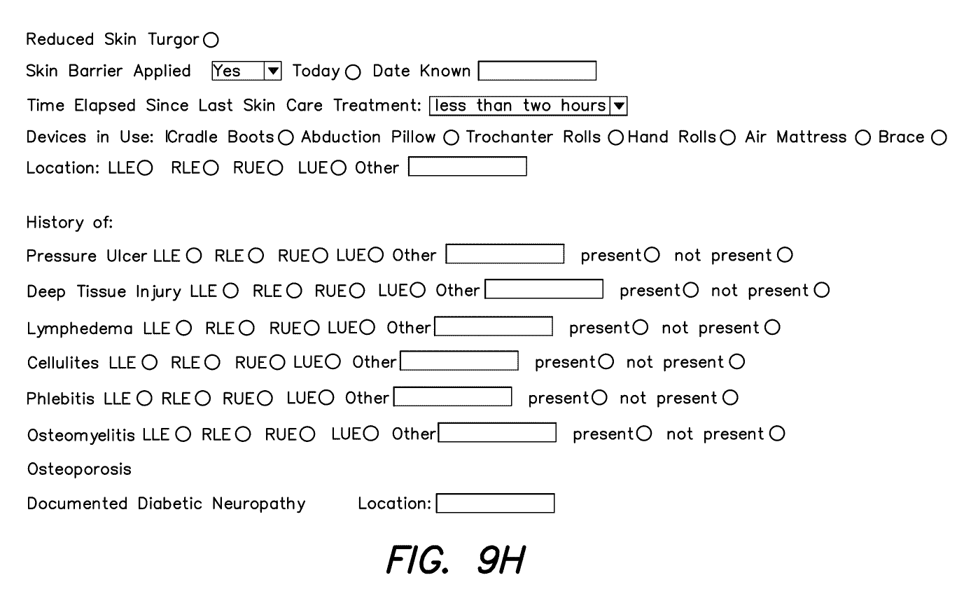

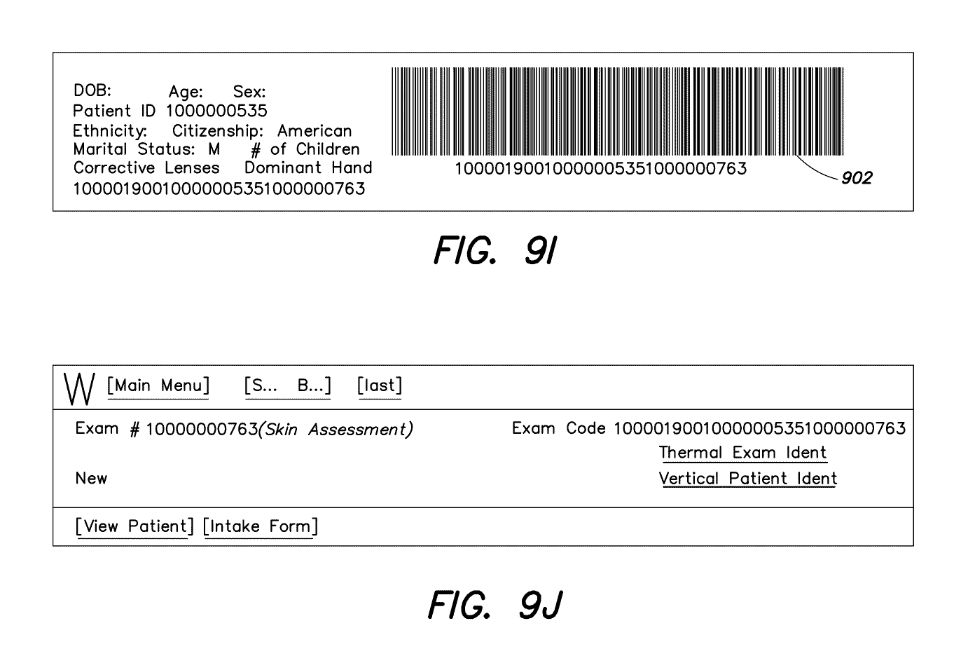

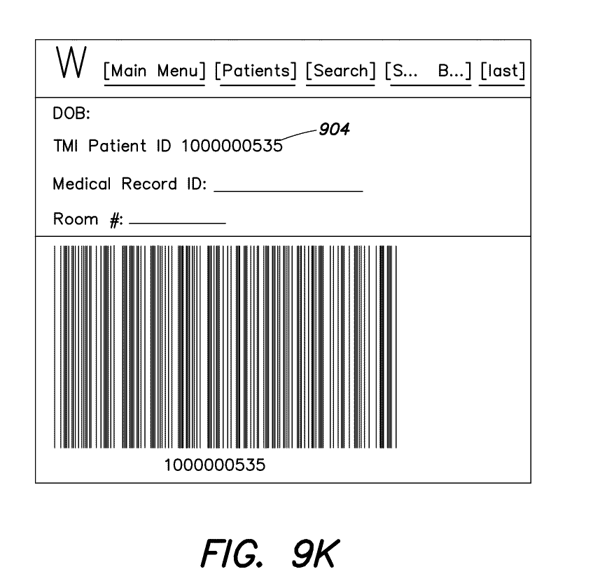

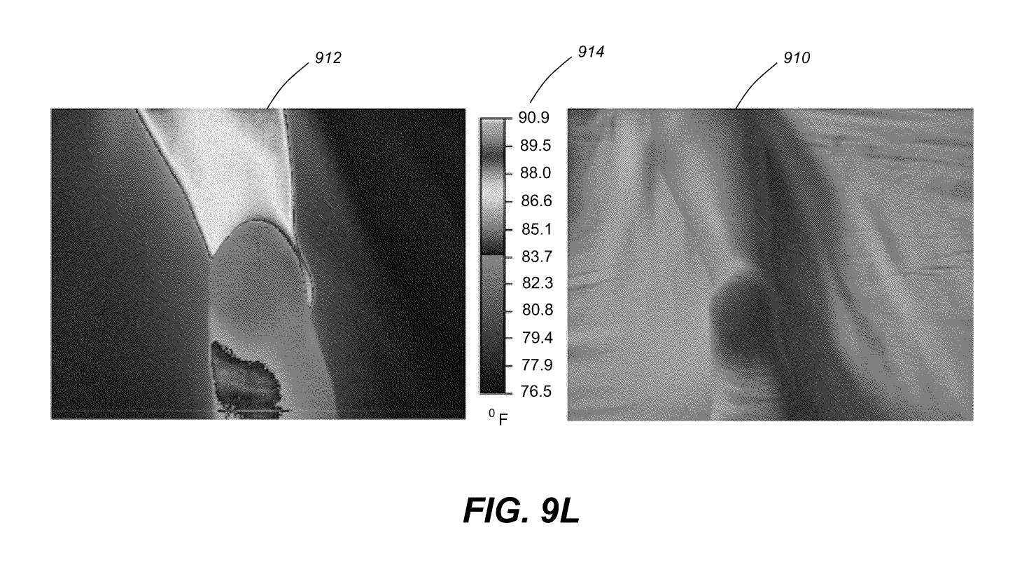

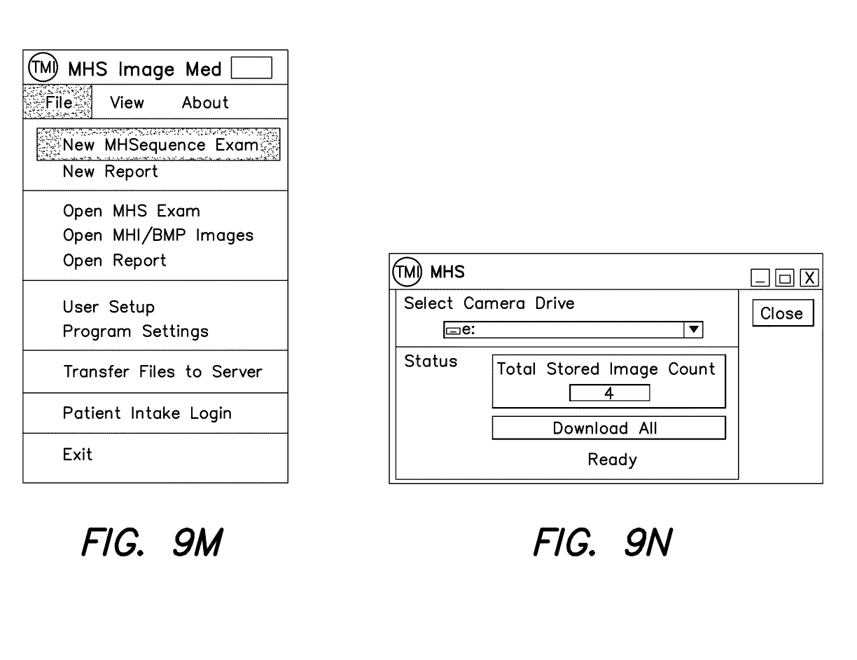

Various user interfaces may be rendered in displays shown on systems 1204-1208. Referring to FIGS. 9A-9O, shown are examples of user interfaces that can be displayed during acquisition of thermal image data and subsequent analysis. FIG. 9B shows a user interface the user can access during the creation of a new subject record, as part of, for example, a new patient intake process. FIG. 9A illustrates a user interface for establishing a connection between a computer system located at a clinic and a thermal image server for storing and processing image data acquired from a subject at the clinic. FIGS. 9C and 9D illustrate user interfaces for adding a new subject and entering pertinent information for the subject. FIG. 9E, illustrates a user interface for selecting an examination type, and in particular a thermal examination by an authorized technician. FIGS. 9F-H, illustrate a user interfaces for inputting questionnaire data for a subject to be imaged.

FIGS. 9I and 9J illustrate in the user interfaces the assignment of an anonymous examination identifier (bar code 902) to a subject to examine and initiation of a new examination using the identifier. FIG. 9K shows a display including an anonymous patient identifier 904, and additional information regarding the subject and location. FIG. 9L illustrates a captured visual image 910 and captured thermal image 912 that can be previewed in a user interface display prior to uploading the files to a thermal medical image server. A displayed thermal image can include a temperature legend 914. The user interface illustrated in FIG. 9N permits the user to transmit any image files via an ftp process after acquisition. Shown in FIG. 9M, is a selection interface for starting an image upload process to a TMI server. Typically, a user selects a new exam option and then uploads any image files for a subject using the interface shown in FIG. 9N. FIG. 9O illustrates an example format of the image files stored for a particular subject. FIGS. 4B and 4C illustrate one example data map format for the captured thermal data.

Referring again to FIG. 12, network 1202 may also include, as part of the system for identifying a pattern of injury from thermal image data, one or more server systems, which may be implemented on general-purpose computers that cooperate to perform various functions including image capture, thermal image processing, thermal data analysis, and other functions. System 1200 may execute any number of software programs or processes and the invention is not limited to any particular type or number of processes. Such processes may perform the various workflows associated with the system for acquiring, managing, and/or analyzing thermal image data to detect a pattern of injury.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the disclosure. Accordingly, the foregoing description and drawings are by way of example only, and the scope of the disclosure should be determined from proper construction of the appended claims, and their equivalents.

We claim:

1. A computer implemented method for identifying a pattern of injury from thermal data, the method comprising acts of:
imaging an area of interest on a subject with a thermal imaging camera to generate thermal image data;
identifying, by a computer processor, at least one temperature value having a temperature variation meeting a first threshold from the thermal image data;
calculating, by the computer processor, a baseline temperature from the thermal image data obtained from the area of interest;
comparing, by the computer processor, each of the at least one temperature values meeting the first threshold against the baseline to determine if a second threshold is satisfied for the at least one temperature value;
identifying the area of interest as being a potential pattern of injury based on the at least one temperature value that meets the second threshold.

2. The method according to claim 1, wherein the temperature variation meeting a first threshold includes a minimum temperature difference between the at least one temperature value and at least one other temperature value within the thermal image data obtained from the area of interest.

3. The method according to claim 1, further comprising an act of identifying the area of interest on the subject to image prior to conducting a thermal examination of the subject.

4. The method according to claim 1, wherein the act of calculating the baseline temperature includes an act of excluding a temperature value from the calculation of the baseline.

5. The method according to claim 4, wherein the temperature value to exclude includes the temperature value meeting the first threshold to be compared against the baseline.

6. The method according to claim 1, wherein the act of comparing each of the temperature values meeting the first threshold against the baseline to determine if the second threshold is satisfied includes an act of determining a minimum temperature difference between at least one temperature value meeting the first threshold and the baseline exists.

7. The method according to claim 1, wherein the act of calculating the baseline temperature from the thermal image data of the area of interest includes acts of:
establishing a mean temperature for the thermal image data;
excluding from the mean temperature a data value meeting the first threshold, wherein the data value excluded comprises the data value to be evaluated against the second threshold.

8. The method according to claim 1, further comprising an act of extracting an inner region of temperature values from the thermal image data obtained from the area of interest, and wherein the acts of identifying, calculating and comparing occur against the inner region.

9. The method according to claim 1, further comprising an act of generating a data map of the thermal image data obtained from the area of interest, wherein a position of each temperature value reflects a distance from a center of the data map.

10. The method according to claim 1, wherein the act of imaging the area of interest includes an act of generating a visual light image of the area of interest.

11. The method according to claim 1, further comprising an act of generating an interpretation request.

12. The method according to claim 11, wherein the interpretation request is generated in response to an automated identification of the pattern of injury.

13. The method according to claim 1, further comprising an act of storing the thermal image data and any subject information anonymously.

14. The method according to claim 1, further comprising an act of generating a probability of pressure ulcer development for the subject based on the pattern of injury.

15. A system for identifying a pattern of injury from thermal image data, the system comprising:
an imaging component configured to capture thermal image data from an area of interest on a subject;
an evaluation component configured to:
identify at least one temperature value having a temperature variation meeting a first threshold from the thermal image data obtained from the area of interest,
calculate a baseline temperature from the thermal image data obtained from the area of interest, and
compare each of the at least one temperature values meeting the first threshold against the baseline to determine if a second threshold is satisfied; and
a communication component configured to generate an alert for an indication of a pattern of injury based on the values that meet the second threshold.

16. The system according to claim 15, wherein the evaluation component is further configured to identify at least one temperature value having a temperature variation meeting a first threshold, by establishing the at least one temperature value meets a minimum temperature difference between the at least one temperature value and at least one other temperature value within the thermal image data obtained from the area of interest.

17. The system according to claim 15, wherein the evaluation component is further configured to calculate the baseline from a mean of temperature values excluding the at least one temperature value to compare against the baseline.

18. The system according to claim 17, wherein the evaluation component is further configured to calculate the baseline for each of the temperature values meeting the first threshold compared against the baseline.

19. The system according to claim 15, wherein the evaluation component is further configured to extract an inner region of temperature values from the thermal image data obtained from the area of interest.

20. The system according to claim 15, wherein the communication component is further configured to generate a request for interpretation.

21. The system according to claim 15, further comprising storage component configured to store subject information and thermal image data anonymously.

22. The system according to claim 15, wherein the evaluation component is further configured to generate a probability of pressure ulcer development for the subject based on the pattern of injury.
